(19) United States
(12) Patent Application Publication
(10) Pub. No.: US 2015/0029067 A1
(43) Pub. Date: Jan. 29, 2015

(54) RF SIGNAL PICKUP FROM AN ELECTRICALLY CONDUCTIVE SUBSTRATE UTILIZING PASSIVE SLITS

(71) Applicants: Hawk Yin Pang, San Jose, CA (US); Rajiv Agarwal, Menlo Park, CA (US); Thomas Alan Donaldson, Nailsworth (GB)

(72) Inventors: Hawk Yin Pang, San Jose, CA (US); Rajiv Agarwal, Menlo Park, CA (US); Thomas Alan Donaldson, Nailsworth (GB)

(73) Assignee: AliphCom, San Francisco, CA (US)

(21) Appl. No.: 14/058,125

(22) Filed: Oct. 18, 2013

Related U.S. Application Data
(63) Continuation-in-part of application No. 13/952,532, filed on Jul. 26, 2013.

(51) Int. Cl. H01Q 13/10

(52) U.S. Cl. CPC H01Q 13/10
USPC 343/770

(57) ABSTRACT

Embodiments of the present application relate generally to electronic hardware, computer software, wireless communications, network communications, wearable, hand-held, and portable computing devices for facilitating communication of information and presentation of media. An electrically conductive substrate (e.g., a metal or metal alloy) includes an antenna formed by a slot or opening formed in the substrate, and also includes at least one separate passive slot or opening (e.g., a passive slit) formed in the substrate. The antenna may be intentionally detuned from one or more target frequencies (e.g., 802.11, 2.4 GHz, 5 GHz) such that the antenna is not optimized (e.g., is not tuned) for the one or more target frequencies. One portion of the antenna may be electrically coupled with a ground potential. Another portion of the antenna may be electrically coupled with a RF receiver, transmitter, or transceiver. The antenna may be an active antenna, a passive antenna or both.

### CROSS-REFERENCE TO RELATED APPLICATIONS

This application is a Continuation-In-Part of pending U.S. patent application Ser. No. 13/952,532, filed on Jul. 26, 2013, having Attorney Docket No. ALI-232, and titled “RADIO SIGNAL PICKUP FROM A METAL SHEET PLANE UTILIZING PASSIVE SLITS”, which is hereby incorporated by reference in its entirety for all purposes. This application is related to the following applications: U.S. patent application Ser. No. 13/957,337, filed on Aug. 1, 2013, having Attorney Docket No. ALI-233, and titled “RF Architecture Utilizing A MIMO Chipset For Near Field Proximity Sensing And Communication”; U.S. patent application Ser. No. 13/919,307, filed on Jun. 17, 2013, having Attorney Docket No. ALI-206, and titled “Determining Proximity For Devices Interacting With Media Devices”; and U.S. patent application Ser. No. 13/802,646, filed on Mar. 13, 2013, having Attorney Docket No. ALI-230, and titled “Proximity-Based Control Of Media Devices For Media Presentations”; all of which are hereby incorporated by reference in their entirety for all purposes.

### FIELD

These present application relates generally to the field of personal electronics, portable electronics, media presentation devices, audio systems, and more specifically to wirelessly enabled devices that may detect and may wirelessly communicate with one another while disposed in near field RF proximity of one another, including in direct contact with one another.

### BACKGROUND

Conventional wireless communication standards, such as those for Bluetooth and WiFi systems (e.g., one or more of the IEEE 802.11xx bands, 2.4 GHz or 5 GHz bands, etc.) allow for a receiver to measure signal strength from an external RF transmitting source, such as smartphone or other wireless device, for example. One measure of signal strength is received signal strength indication (RSSI). RSSI may be regarded as an indication of RF power being received by an antenna of the receiving wireless device. High RSSI values are indicative of a strong signal and low RSSI values are indicative of a weak signal. In that the RSSI is a relative measure of received signal strength, the units of measure for RSSI may be in arbitrary units. For example, in one application RSSI may be assigned arbitrary units of 0 to 100 or 0 to some maximum value of RSSI. Therefore, units of actual measured power, such as mW or dBm need not be used and may not be helpful in determining relative strength or weakness of received signal strength in a wireless environment.

In some applications it is desirable to use RSSI to estimate distance between the transmitting device and the receiving device. For example, if the transmitting device and receiving device are approximately 10 cm away from each other, then the RSSI should be stronger than when they are 1 meter away from each other. However, there are known difficulties in using RSSI readings for accurate distance measurements due to many factors including but not limited to: (a) multipath effects caused by RF signal reflection off surrounding objects such as walls, moving objects, and stationary objects; (b) differences in antenna radiation patterns and polarization patterns of the transmitting and receiving antennas; and (c) RF interference generated by other radiators of RF energy in the wireless environment of the receiver that is attempting to measure the RSSI of a specific transmitter; just to name a few. Generally, close distance RSSI measurements may be made with a higher accuracy than long distance measurements due to the inverse square power drop off of the RF signal (i.e., 1/R²) in the far field region and a greater drop off (e.g., greater than 1/R³) in the near field region. Close proximity sensing using RSSI has a statistically higher level of accuracy and a receiving device may infer that it is in close proximity to a transmitting device when both devices are close to one another. However, there remains a small probability that a false alarm may be triggered when the RSSI indicates close proximity when in fact the two devices are not in close proximity to each other.

Thus, there is a need for systems that allow for accurate RF signal detection to be made in close proximity between transmitting and receiving devices without relying solely on RSSI information or that don't use RSSI information for determining proximity.

### BRIEF DESCRIPTION OF THE DRAWINGS

Various embodiments or examples (“examples”) of the present application are disclosed in the following detailed description and the accompanying drawings. The drawings are not necessarily to scale:

FIG. 1A depicts a top plan view of one example of an antenna and passive slits formed in a substrate of an electrically conductive material, according to an embodiment of the present application;

FIG. 1B depicts a cross-sectional view along line AA-AA of FIG. 1A of an antenna and passive slits formed in a substrate of an electrically conductive material, according to an embodiment of the present application;

FIG. 1C depicts an example schematic diagram of electrical connections with the antenna, according to an embodiment of the present application;

FIGS. 1D-1G are top plan views depicting examples of configurations for an antenna and passive slits formed in a substrate of an electrically conductive material, according to an embodiment of the present application;

FIGS. 1H-1M depict examples of different perforate materials for a substrate of an electrically conductive material, according to an embodiment of the present application;

FIG. 2 depicts an exemplary computer system according to an embodiment of the present application;

FIGS. 3A-3F depicts profile views of example configurations of an antenna and passive slits formed in a substrate of an electrically conductive material that is positioned on a system, according to an embodiment of the present application;

FIGS. 4A-4B depict examples of a live device generating a RF signal that may be detected by a system using an antenna and passive slits, according to an embodiment of the present application;

FIG. 5 depicts a plot of RSSI measurements for a conventional system that uses an antenna and does not use passive slits;

FIG. 6 depicts a plot of RSSI measurements for a system using an antenna and passive slits, according to an embodiment of the present application;

FIG. 7 depicts a flow diagram for detecting a live device using a system having an antenna and passive slits, according to an embodiment of the present application;

FIG. 8 depicts a flow diagram for detecting a live system using a device having an antenna and passive slits, according to an embodiment of the present application;

FIG. 9A depicts front, side, and back views of a device that includes an antenna and passive slits, according to an embodiment of the present application;

FIG. 9B depicts the device of FIG. 9A being positioned directly on top of a live system, according to an embodiment of the present application;

FIG. 10A depicts a schematic diagram of one example of an antenna electrically coupled with a RF system, according to an embodiment of the present application;

FIG. 10B depicts a schematic diagram of another example of an antenna electrically coupled with a RF system, according to an embodiment of the present application;

FIGS. 11A-11E depict different use examples for the antenna/passive slit detection system, according to an embodiment of the present application;

FIG. 12A depicts a block diagram of one example of a RF frontend architecture, according to an embodiment of the present application;

FIG. 12B depicts a schematic of one example of a RF proximity detection antenna coupled with a RF switch, according to an embodiment of the present application;

FIG. 12C depicts a block diagram of the RF frontend architecture of FIG. 12A when set to a 2×2 MIMO mode, according to an embodiment of the present application; and

FIG. 12D depicts a block diagram of the RF frontend architecture of FIG. 12A when set to a 1×2 MIMO mode, according to an embodiment of the present application.

### DETAILED DESCRIPTION

Various embodiments or examples may be implemented in numerous ways, including as a system, a process, an apparatus, a user interface, or a series of program instructions on a non-transitory computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying drawing FIGS. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

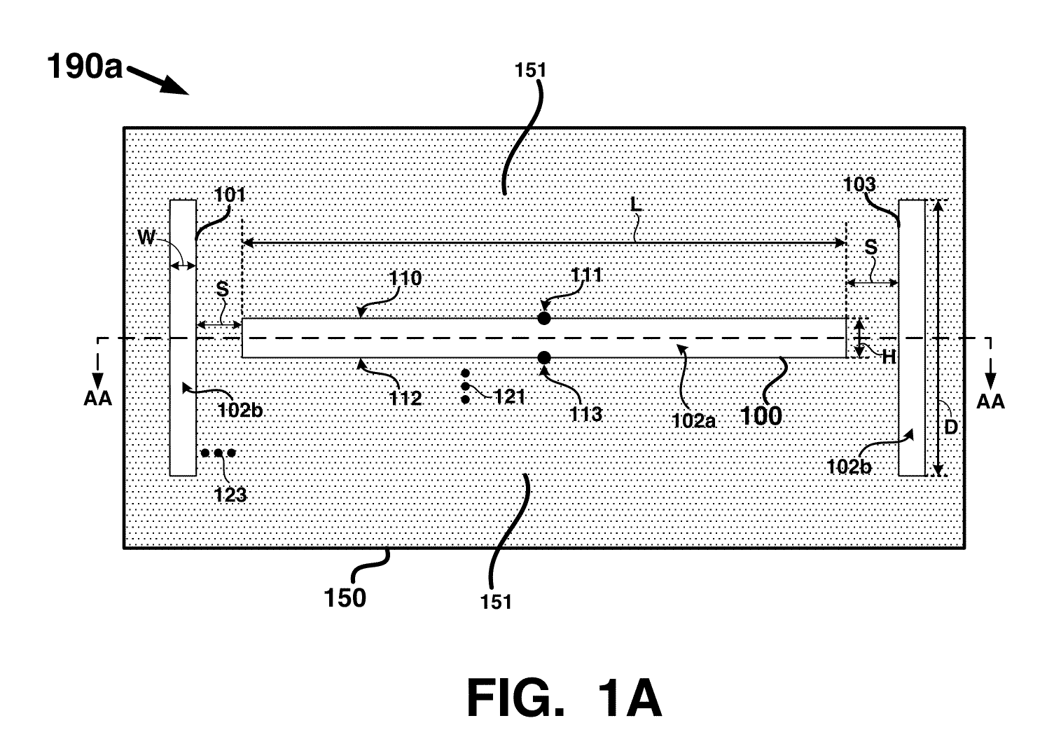

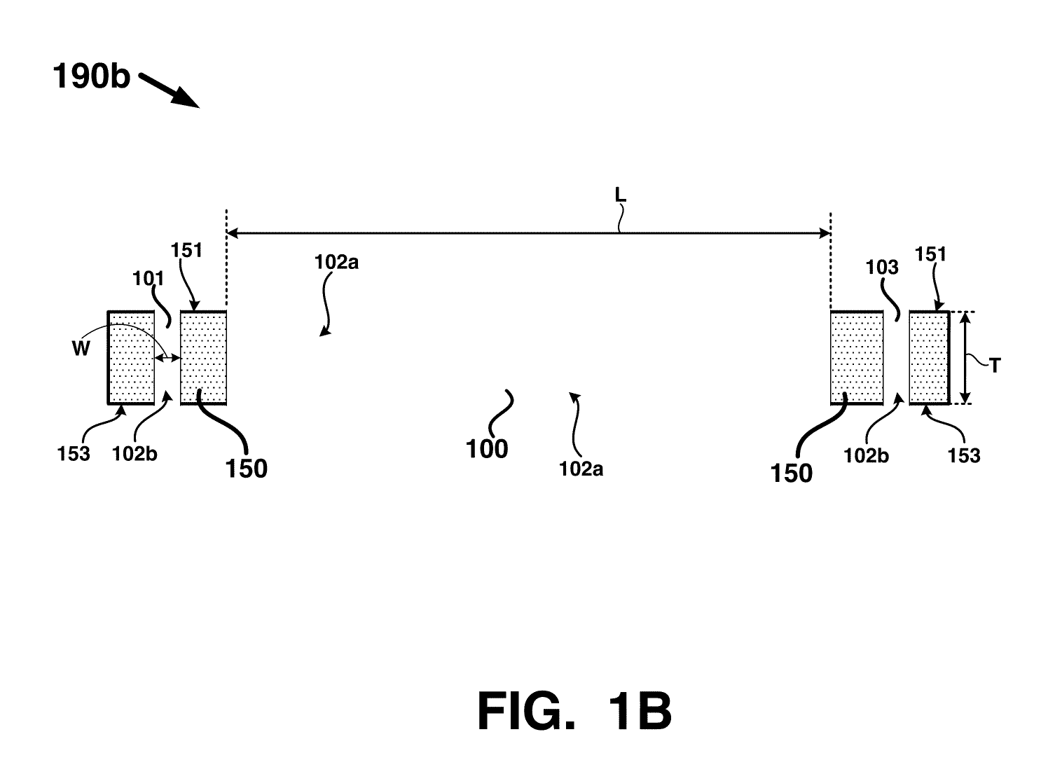

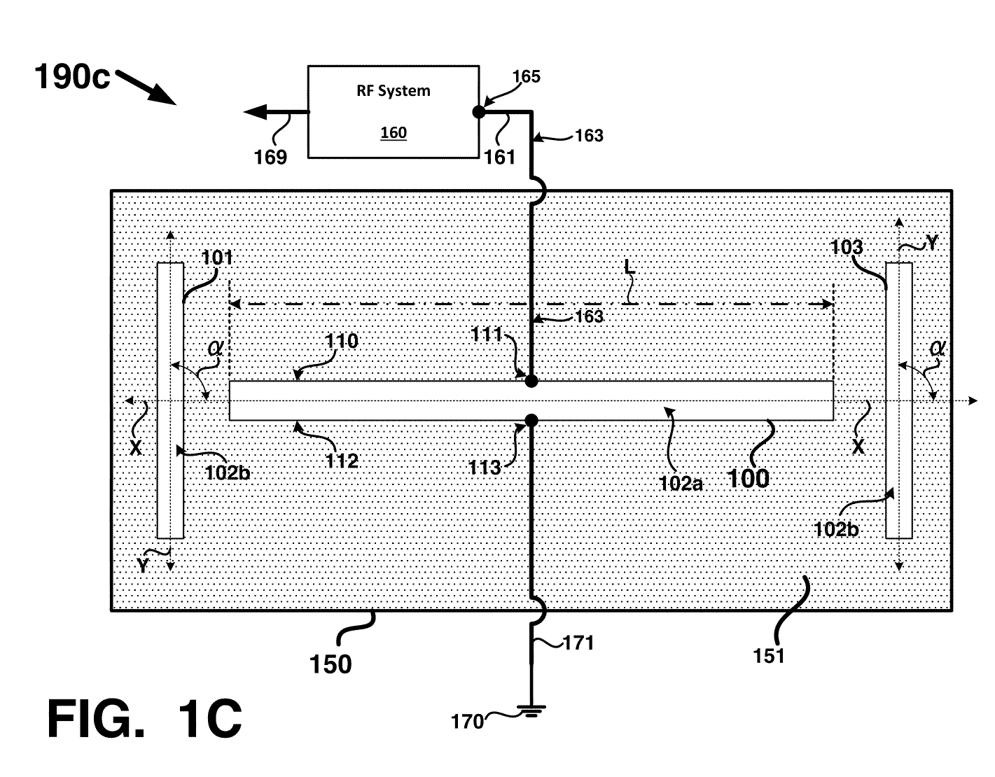

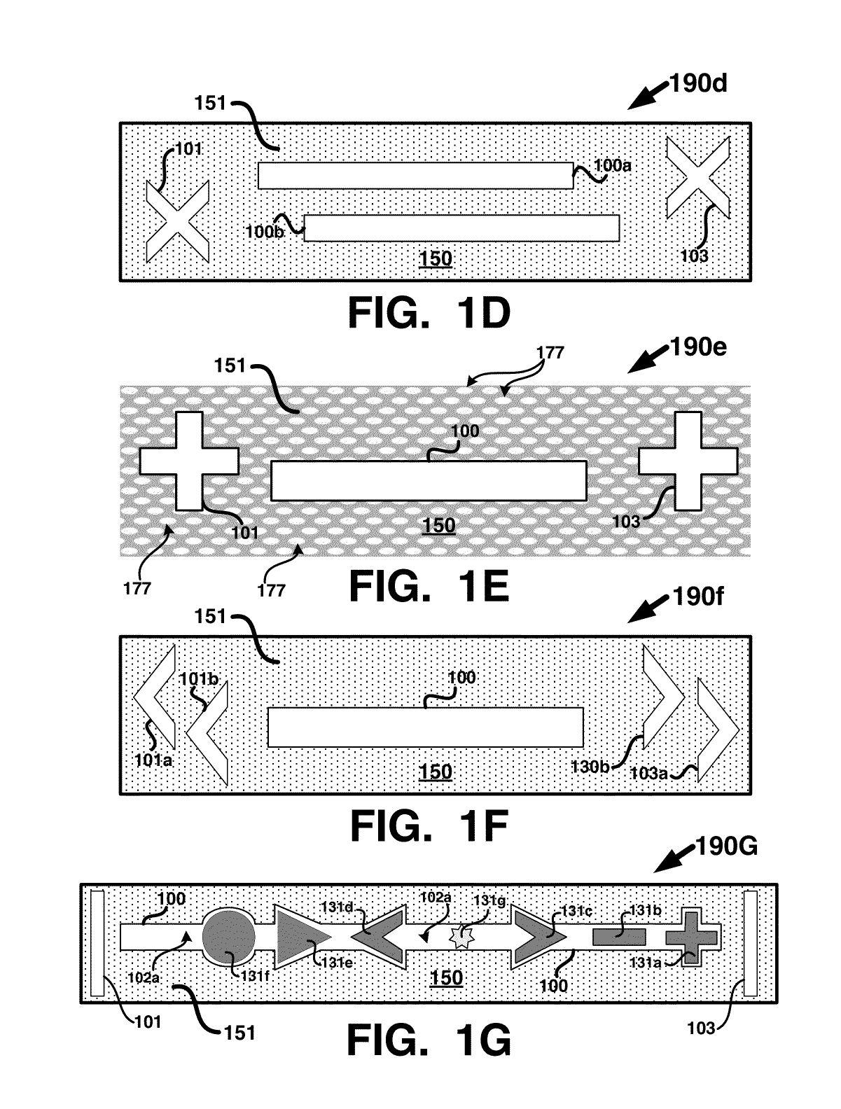

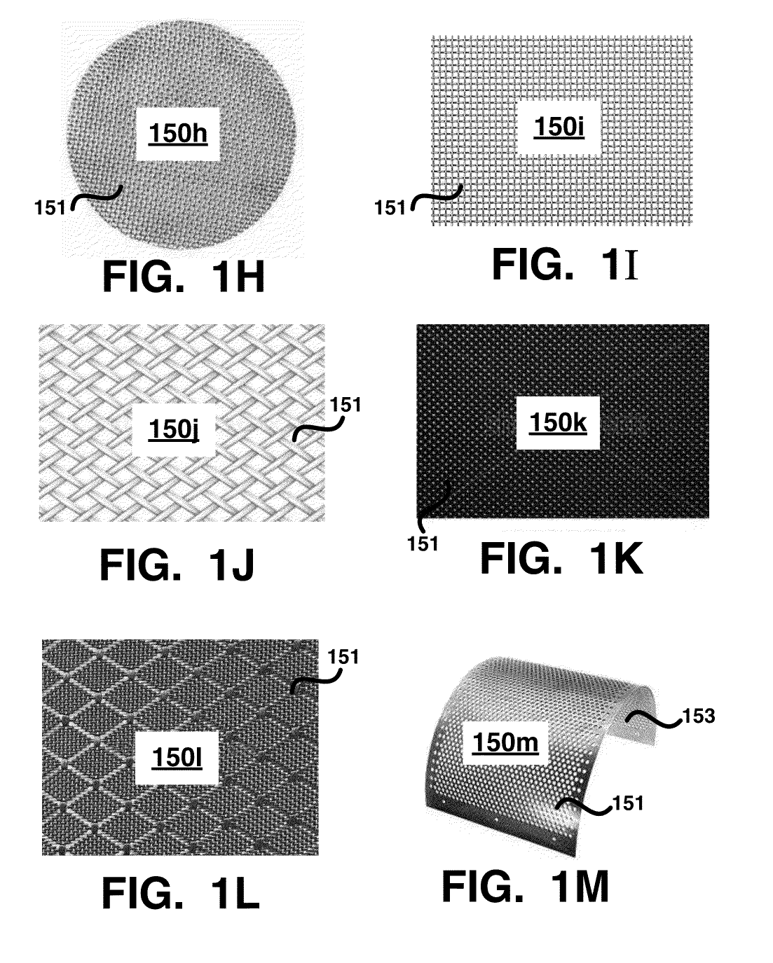

FIG. 1A depicts a top plan view 190a of a substrate of an electrically conductive material 150 in which a plurality of separate apertures (e.g., holes or openings) are formed. Here, those separate apertures are depicted looking down on a surface 151 of the substrate 150. Therefore, the separate apertures may be described as through holes formed in the substrate 150 that extend all the way through the substrate 150 as will be described in greater detail in FIG. 1B.

One or more of the separate apertures comprises an antenna 100 having a length dimension L that is substantially larger that a width dimension H. For example, if antenna 100 has the shape of a rectangle as depicted in FIG. 1A, then H is much less than L (e.g., H<<L), such that if L is 150 mm then H may be 10 mm or less (e.g., H=3.5 mm). Actual shapes and dimensions of the antenna 100 may be application dependent and are not limited to the configuration depicted in FIG. 1A or in any other figures herein. One edge 110 of antenna 100 is electrically coupled with a radio frequency (RF) system (not shown) (e.g., a RF receiver, RF transmitter or RF transceiver) and an opposite edge 112 is electrically coupled with a ground potential (not shown) (e.g., a ground—GND or chassis ground). Edges 110 and 112 are along a length dimension of the antenna 100. As one example, a node 111 on edge 110 may be electrically coupled with the RF system and another node 113 on the opposite edge 112 may be electrically coupled with the ground potential. In some examples, the electrical connections for nodes 111 and 113 may be reversed and node 113 electrically coupled with the RF system and node 111 electrical coupled with the ground potential. Although the position of the electrical connections to the edges 110 and 112 are depicted directly opposite each other, that is node 111 is directly opposite node 113, the nodes may be positioned along their respective edges at other locations and the configuration depicted is a non-limiting example. Although one antenna 100 is depicted there may be a plurality of antennas 100 as denoted by 121.

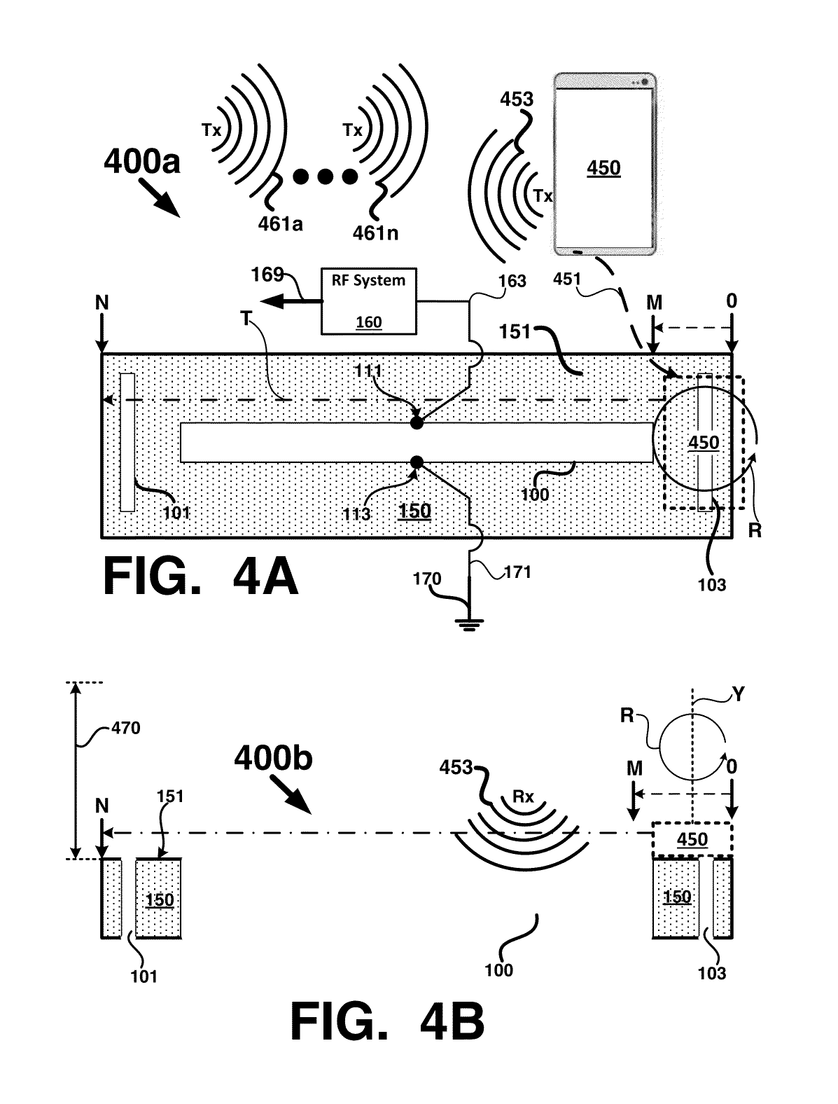

Substrate 150 also includes one or more apertures that define a passive slit denoted as 101 and 103. Although two passive slits (101, 103) are depicted there may be just a single passive slit or more than two passive slits as denoted by 123. Moreover, the relative position on the substrate 150 of the passive slit(s) and the antenna(s) are not limited to the configurations depicted in FIG. 1A or in other figures herein and the actual size, shape, dimensions, and positions of the passive slit(s) and/or antenna(s) may be application dependent. Passive slits (101, 103) are not electrically coupled with circuitry, the ground potential, or the RF system. Passive slits (101, 103) are passive structures formed in the substrate 150 and may operate to modify current flow along substrate 150 generated by interaction of an external RF signal with antenna 100 as will be described below in reference to FIGS. 4A-6. Passive slits (101, 103) are not driven by circuitry nor do they generate a signal that is coupled with circuitry.

Typically, dimensions of the passive slits (101, 103) may be much less than similar dimensions of the antenna 100. For example, if the passive slits (101, 103) are rectangular in shape as depicted in FIG. 1A, then a width dimension W of passive slits (101, 103) may be less than the width dimension H of the antenna 100. For example, if H is 5 mm, then W may be 1.5 mm. Moreover, if the length L of the antenna is 150 mm then length D may be 53 mm for the passive slits (101, 103). In some examples, one or more of the passive slits may have a length D that is not shorter than the length L of the antenna 100 or D is less than L but not by a large amount, such as when D=53 mm and L=150 mm as in the example above. For example, dimensions of L and D may be: L=170 mm and D=180 mm; or L=130 mm and D=115 mm. Actual dimensions of L and D, and/or H and W will be application dependent and are not limited to the examples described herein. Passive slits (101, 103) may be placed at various positions along surface 151 of substrate 150, such as opposite ends of antenna 100, for example. In that the plurality of apertures are spatially separate from one another, passive slits (101, 103) may be spaced apart from antenna 100 by a distance S that may be the same or different for each passive slit (101, 103). The antenna 100 may be tuned to the target frequency or in some examples may be detuned to a frequency range that is below (i.e., lower) that of the target frequency or a frequency range that is above (i.e., greater) that of the target frequency. Therefore, the antenna 100 may have its dimensions (e.g., the L dimension) selected to tune or to de-tune the antenna 100 relative to a target frequency, such as a target frequency to be detected by a RF system or RF receiver that is electrically coupled with the antenna 100. De-tuning may be above or below the target frequency. Antenna 100 may have a vertical polarization pattern. Computer aided design (CAD) software, tools, and the like may be used to design and simulate the RF parameters and performance of the antenna 100 and passive slit (101, 103) for a particular design. CAD tools including but not limited to Method of Moments EM, Momentum 3D Planar EM simulator, and ANSYS Electromagnetic Simulator for RF and antennas may be used.

In that the antenna 100 and passive slits (101, 103) are apertures formed in substrate 150, a void in the opening defined by the apertures, denoted as 102a for the antenna 100 and 102b for the passive slits (101, 103), may be occupied by air or some other electrically non-conductive material, medium, dielectric material, or composition of matter. Examples of suitable electrically non-conductive materials includes but is not limited to rubber, plastics, foam, glass, Plexiglas, wood, stone, a gas, paper, inert organic or inorganic materials, cloth, leather, a non-conductive liquid, Teflon, PVDF, minerals, just to name a few. A material that occupies the void/opening may be selected for a functional purpose, an esthetic purpose, or both. In some applications a functional element such as a switch, button, actuator, indicator (e.g., a LED), microphone, transducer, or the like may be positioned in void/opening (102a, 102b). In other applications the material disposed in the void/opening (102a, 102b) may include a logo, a trademark, a service mark, ASCII characters, graphics, patterns, one or more esthetic features, instructions, or the like.

Moving on to FIG. 1B, a cross-sectional view 190b of the substrate 150 depicts in greater detail the void/opening (102a, 102b) of the apertures for antenna 100 and passive slits (101, 103). Surfaces 151 and 153 of substrate 150 are depicted as being substantially parallel to each other; however, substrate 150 may have a thickness T that varies and need not be flat, planar, or smooth. Moreover, substrate 150 may have a shape including but not limited to an arcuate shape, curvilinear shape, an undulating shape, and a complex shape, just to name a few. Substrate 150 may be made from a perforate material (see FIG. 1E) such as a screen, mesh, or material with perforations in it.

Attention is now directed to FIG. 1C where a schematic diagram 190c depicts one example of how the opposing sides (110, 112) along the length L dimension of the antenna 100 may be electrically coupled. Node 111 on side 110 is electrically coupled 163 with a RF system 160. The RF system 160, antenna 100 and its associated passive slits (e.g., 101 and 103) may also be referred to as a detection system herein. The electrical coupling 163 may be made using a variety of connection techniques including but not limited to a RF feed, coaxial cable, a wire, a shielded connection, an unshielded connection, a partially shielded connection, an electrically conductive trace, just to name a few. A node 165 of the RF system 160 may include a termination device 161, such as a SMA connector or the like, configured to make an impedance matching termination, such as 50 ohms, for example. Node 113 on side 112 is electrically coupled 171 with a ground potential 170. The ground potential 170 may include but is not limited to a chassis ground, circuit ground, and power supply ground, just to name a few. The actual selection of the appropriate ground potential may be application dependent and is not limited to the ground potentials described herein. The electrical coupling 171 may use any suitable electrical connection medium including but not limited to wire, a conductive trace, a cable, and a coaxial cable, just to name a few. RF system 160 may include one or more RF devices including but not limited to RF transceivers for WiFi, Bluetooth, Ad Hoc WiFi, RF transceivers, RF receivers, and RF transmitters. RF system 160 may include a RF device configured for and/or devoted to operation with antenna 100 (e.g., a RF receiver). RF system 160 may generate one or more signals on an output 169 in response to RF signals received by antenna 100.

In FIG. 1C, an axis X of the antenna 100 is depicted as being orthogonal to an axis Y of the passive slits (101, 103). However, the configuration depicted is just one non-limiting example and the axis of the antenna 100 and passive slits (101, 103), if any, need not have a particular angular orientation. For example, angle α as measured between the X and Y axes need not be 90 degrees (e.g., a right angle) and other angular relationships may be used. Furthermore, any angular relationship between axes of the antenna 100 and the passive slits (101, 103) may vary such that α for 103 may be different than α for 101.

FIGS. 1D-1G depict top plan views of examples 190d-190g for different configurations for an antenna 100 and passive slits (101, 103) formed in a substrate 150 and different configurations for the substrate 150. The examples depicted are non-exhaustive and non-limiting examples of different configurations that may be used. Moreover, the examples may include more or fewer antennas and passive slits than depicted in FIGS. 1D-1G. In FIG. 1D, example 190d depicts a substrate 150 that includes two antennas (100a, 100b) having a rectangular shape and two passive slits 101 and 103 having a “X” shape. Moreover, there is no particular symmetrical relationship between the antennas (100a, 100b) and passive slits (101, 103). In FIG. 1E, example 190e depicts a substrate 150 comprised of a perforate article having a plurality of perforations 170 (e.g., through holes) distributed across its surface 151. Perforations 170 are substantially smaller than the plurality of separate apertures for the antenna 100 and cross-shaped “+” passive slits (101, 103). FIGS. 1H-1M depict other non-limiting examples of substrates 150h-150m comprised of perforate materials having perforations similar to perforations 170.

FIG. 1F depicts an example 190f in which there is one antenna 100 having a rectangular shape and a plurality of passive slits (101a, 101b, 103a, 103b) having a chevron shape. In FIG. 1G, example 190g depicts a substrate 150 having two rectangular shaped passive slits (101, 103) and an antenna 100 having a complex shape configured to match a contour of one or more elements 131a-131f that are positioned in the aperture 102a (e.g., void/opening) of antenna 100. As one example, elements 131a-131f may be switches electrically coupled with circuitry of a device or system (not shown) that includes the substrate 150. Elements 131a-131f may be made from an electrically non-conductive material such as rubber, plastic, or a dielectric material, for example. Aperture 102a may be filled with the material used for the elements 131a-131f or may be a combination of air and the material used for the elements 131a-131f, for example. Examples of functional roles for elements 131a-131f include but are not limited to: 131a “+” for volume up; 131b “−” for volume down; 131c to go forward one track in a playback of content; 131d to go back one track in a playback of content; 131e to commence playback of content; and 131f to stop or halt playback of content. One or more of the elements 131a-131f may serve multiple functions, such as element 131f functioning to stop or halt playback of content when pressed by a user's fingers and also functioning to pair a system that includes the substrate 150 with another wireless device, such as Bluetooth paring of devices, for example. Aperture 102a may include other elements such as element 131g that may be operative as an indicator light (e.g., LED) to indicate status such as “power on”, “paring mode”, or “standby mode”, for example. Element 131g may be a microphone or other type of transducer, for example.

FIG. 2 depicts an exemplary computer system 200 suitable for use in the systems, methods, and apparatus described herein. In some examples, computer system 200 may be used to implement circuitry, computer programs, applications (e.g., APP's), configurations (e.g., CFG's), methods, processes, or other hardware and/or software to perform the above-described techniques. Computer system 200 includes a bus 202 or other communication mechanism for communicating information, which interconnects subsystems and devices, such as one or more processors 204, system memory 206 (e.g., RAM, SRAM, DRAM, Flash), storage device 208 (e.g., Flash, ROM), disk drive 210 (e.g., magnetic, optical, solid state), communication interface 212 (e.g., modem, Ethernet, WiFi), display 214 (e.g., CRT, LCD, touch screen), one or more input devices 216 (e.g., keyboard, stylus, touch screen display), cursor control 218 (e.g., mouse, trackball, stylus), one or more peripherals 240. Some of the elements depicted in computer system 200 may be optional, such as elements 214-218 and 240, for example and computer system 200 need not include all of the elements depicted.

According to some examples, computer system 200 performs specific operations by processor 204 executing one or more sequences of one or more instructions stored in system memory 206. Such instructions may be read into system memory 206 from another non-transitory computer readable medium, such as storage device 208 or disk drive 210 (e.g., a HD or SSD). In some examples, circuitry may be used in place of or in combination with software instructions for implementation. The term “non-transitory computer readable medium” refers to any tangible medium that participates in providing instructions to processor 204 for execution. Such a medium may take many forms, including but not limited to, non-volatile media and volatile media. Non-volatile media includes, for example, optical, magnetic, or solid state disks, such as disk drive 210. Volatile media includes dynamic memory, such as system memory 206. Common forms of non-transitory computer readable media includes, for example, floppy disk, flexible disk, hard disk, SSD, magnetic tape, any other magnetic medium, CD-ROM, DVD-ROM, Blu-Ray ROM, USB thumb drive, SD Card, any other optical medium, punch cards, paper tape, any other physical medium with patterns of holes, RAM, PROM, EPROM, FLASH-EPROM, any other memory chip or cartridge, or any other medium from which a computer may read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 202 for transmitting a computer data signal. In some examples, execution of the sequences of instructions may be performed by a single computer system 200. According to some examples, two or more computer systems 200 coupled by communication link 220 (e.g., LAN, Ethernet, PSTN, or wireless network) may perform the sequence of instructions in coordination with one another. Computer system 200 may transmit and receive messages, data, and instructions, including programs, (i.e., application code), through communication link 220 and communication interface 212. Received program code may be executed by processor 204 as it is received, and/or stored in a drive unit 210 (e.g., a SSD or HD) or other non-volatile storage for later execution. Computer system 200 may optionally include one or more wireless systems 213 in communication with the communication interface 212 and coupled (215, 223) with one or more antennas (217, 225) for receiving and/or transmitting RF signals (221, 227), such as from a WiFi network, BT radio, or other wireless network and/or wireless devices, for example. Examples of wireless devices include but are not limited to: a data capable strap band, wristband, wristwatch, digital watch, or wireless activity monitoring and reporting device; a smartphone; cellular phone; tablet; tablet computer; pad device (e.g., an iPad); touch screen device; touch screen computer; laptop computer; personal computer; server; personal digital assistant (PDA); portable gaming device; a mobile electronic device; and a wireless media device, just to name a few. Computer system 200 in part or whole may be used to implement one or more systems, devices, or methods using the antenna 100 and passive slits (101, 103) as described herein. For example, a radio (e.g., a RF receiver) in wireless system(s) 213 may be electrically coupled 231 with an edge 110 (e.g., at 111 or other location on the edge) of the antenna 100. Computer system 200 in part or whole may be used to implement a remote server or other compute engine in communication with systems, devices, or method using the antenna 100 and passive slits (101, 103) as described herein.

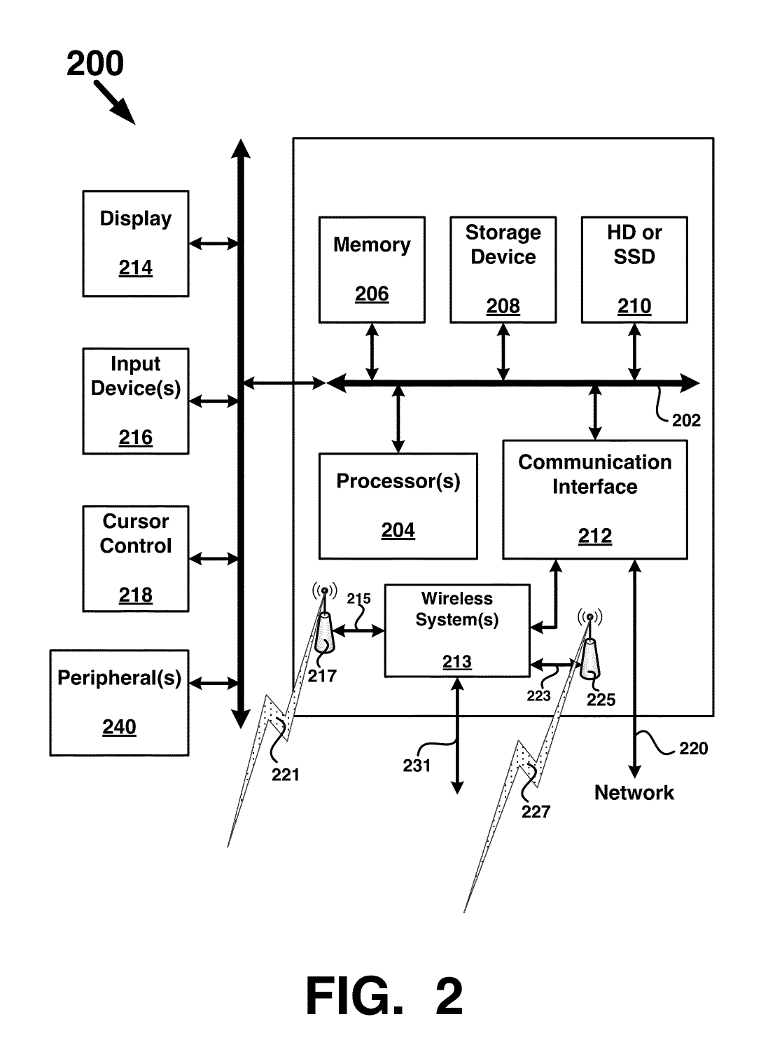

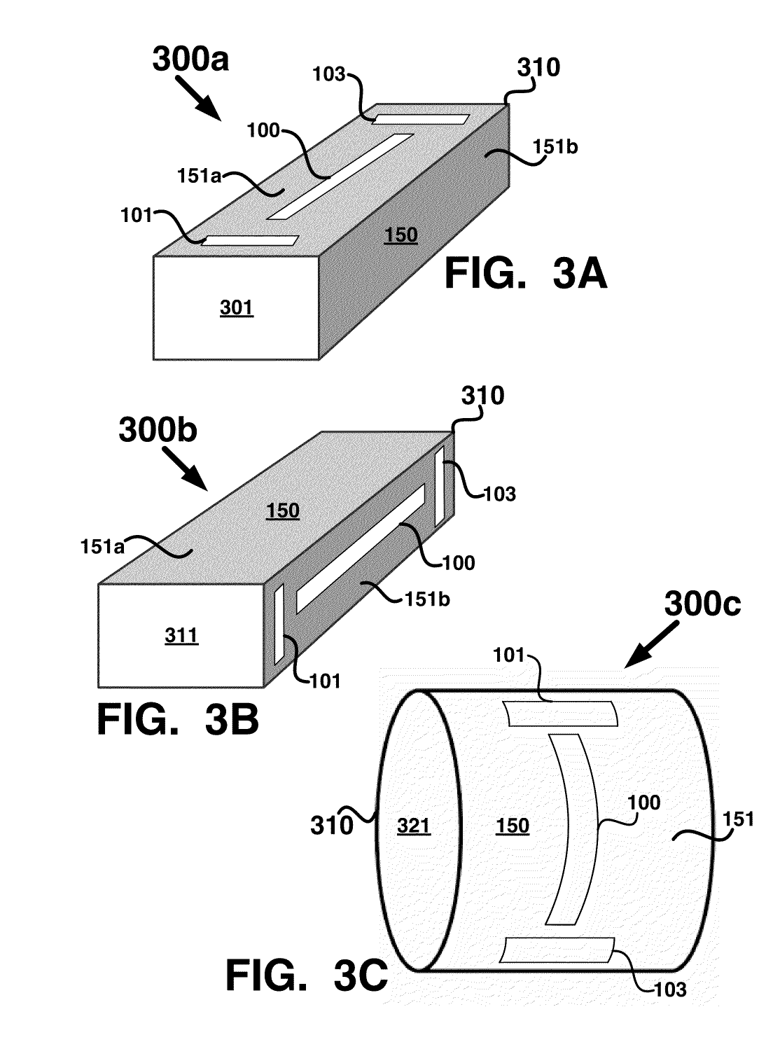

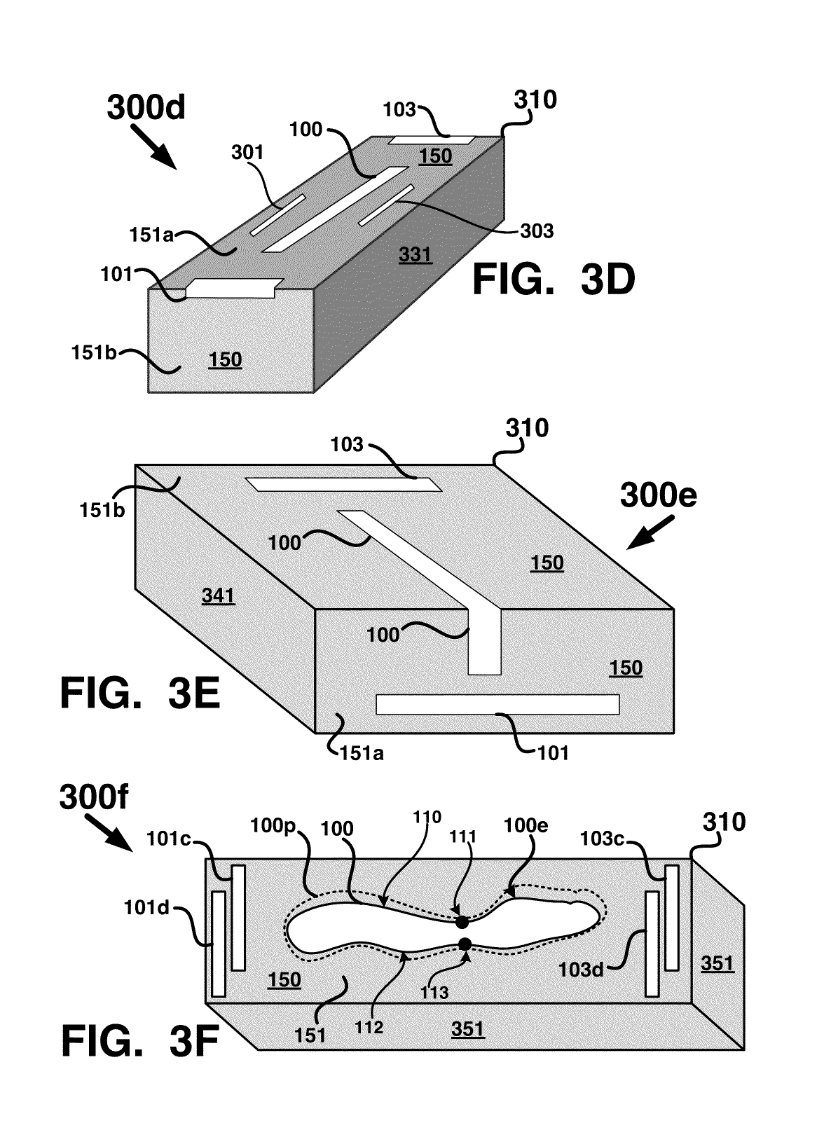

Reference is now made to FIGS. 3A through 3F where profile views of example configurations of an antenna and passive slits formed in a substrate of an electrically conductive material are depicted. In FIG. 3A, a system 300a includes a many sided enclosure 310 (e.g., a chassis or housing) including on at least two of its side the substrate 150 of an electrically conductive material and other sides, such as side 301 that are made from a non-electrically conductive material. The side 301 is electrically non-conductive as may be the case for other sides not visible in FIG. 3A. Here, passive slits (101, 103) and antenna 100 are formed in surface 151a of one of the sides of the substrate 150. Although enclosure 310 is depicted as having a box or rectangular shape, the actual shape of enclosure 310 will be application dependent and is not limited to the shapes depicted in FIGS. 3A-3F. Enclosure 310 of system 300a may serve many functions, such as a wireless speaker media/content playback system that may connect with or otherwise pair with other wireless devices to negotiate content transfer to/from the other wireless devices, for example. RF system 160 in conjunction with passive slits (101, 103) and antenna 100 may be used to detect RF signals transmitted by the other wireless devices when those devices are positioned directly on surface 151a or positioned in near field proximity or very close near field proximity of substrate 150 (e.g. surface 151a). Very close near field proximity may comprise a distance from the substrate where the passive slits (101, 103) and antenna 100 are positioned that is approximately 0.5 meters or less. More preferably, 50 mm or less. Even more preferably, 30 mm or less. Near field proximity may comprise a distance that is greater than 0.5 meters. The foregoing are non-limiting examples of what may define near field proximity or very close near field proximity and actual values will be application dependent.

In FIG. 3B, system 300b includes an enclosure 310 in which the passive slits (101, 103) and antenna 100 are positioned on a different side of the enclosure 310. A side 311 of enclosure 310 is electrically non-conductive and other sides not visible in FIG. 3B may also be electrically non-conductive. Here, surface 151b of substrate 150 includes the passive slits (101, 103) and antenna 100. Therefore, the passive slits (101, 103) and antenna 100 may be positioned on the substrate 150 in a variety of configurations that may be determined on an application specific basis.

In FIG. 3C, system 300c includes an enclosure 310 having a cylindrical shape. A side 321 is electrically non-conductive and surface 150 includes the passive slits (101, 103) and antenna 100. Therefore, surface 150 and its corresponding passive slits (101, 103) and antenna 100 may have an arcuate shape or other non-linear or curvilinear shape. The side 321 is electrically non-conductive as may be the case for other sides not visible in FIG. 3C.

In FIG. 3D, a system 300d includes four (4) passive slits (101, 103, 301, 303) formed in substrate 150 which spans several sides of enclosure 310. A side 331 is electrically non-conductive as may be the case for other sides not visible in FIG. 3D. Passive slits 101 and 103 span two different sides of substrate 150 and are formed on surfaces 151a and 151b; whereas, passive slits 301 and 303 are formed only on one side of substrate 150 and are formed in surface 151a along with a single antenna 100.

In FIG. 3E, a system 300e includes an enclosure 310 in which surfaces 151a and 151b have a portion of antenna 100 formed therein. Moreover, substrate 150 includes two passive slits formed on different sides of the enclosure 310, with one of the slits 103 formed in surface 151b and the other slit formed in surface 151a. A side 341 is electrically non-conductive as may be the case for other sides not visible in FIG. 3E.

In FIG. 3F, a system 300f includes a substrate 150 having four passive slits (101c, 101d, 103c, 103d) and an antenna 100 having a complex profile (e.g., along its perimeter 100p). Sides 351 are electrically non-conductive as may be the case for other sides not visible in FIG. 3F. Due to the complex profile of antenna 100, the location of the opposing sides is not as straight forward as in the case where the antenna 100 has a regular shape (e.g., a rectangle). Here, opposing sides 110 and 112 vary in distance from each other along the perimeter 100p (shown in dashed line). Accordingly, the points along the edges for positioning the nodes 111 and 113 may be a matter of design choice. For example, nodes 111 and 113 may be positioned at a narrow portion of the antenna 100 were the opposing sides are closest to each other. Here, in this example where the antenna 100 has a complex shape, a distance 100e around the perimeter 100p may be selected so that the antenna 100 may be detuned from a target frequency by at least a wavelength of the target frequency divided by two (e.g., λ/2). In other examples, the dimensions of the antenna 100 (e.g., the length) may be selected to tune the antenna 100 to a target frequency. The target frequency will be application dependent and the antenna 100 and passive slits (101, 103) may be designed to accommodate the needs of specific design goals for each application. Examples of target frequencies include but are not limited to: 2.4 GHz; 2.4 GHz-2.48 GHz; from about 2.4 GHz to about 2.48 GHz; 5 GHz; unlicensed bands, licensed bands, cellular bands, bands used by 2G, 3G, 4G, and 5G devices, Bluetooth bands, any of the IEEE 802.11 bands (e.g., 802.11a, 802.11b, 802.11g, 802.11n, 802.11ac, 802.11ad, etc.), military bands, just to name a few. The antenna 100 may be tuned to the target frequency or in some examples may be detuned to a frequency range that is below that (i.e., lower) of the target frequency or a frequency range that is above (i.e., greater) that of the target frequency.

Turning now to FIGS. 4A-4B were examples of a live device generating a RF signal that may be detected by a system using an antenna and passive slits are depicted. In FIGS. 4A-4B, nodes 111 and 113 may be connected as described in reference to FIG. 1C above. A live device 450 is transmitting Tx a RF signal 453. There may also be other RF sources in an environment in which the live device 450 and/or substrate 150 (and its associated system) reside and those RF sources are denoted as transmitting Tx sources 461a-461n. For purpose of discussion, a live device may be, without limitation, a device that is actively transmitting Tx a RF signal or may be activated (e.g., turned on, controlled or commanded) to transmit Tx a RF signal. As one example, a smartphone transmitting Tx RF using any one of its radios (BT, WiFi, 3G, 4G, 5G, 802.11, etc.) may be a live device. If the smartphone is powered off or in airplane mode, where it is not transmitting Tx RF, then the smartphone may not be a live device.

In FIGS. 4A-4B, live device 450 is placed 451 directly on surface 151 of substrate 150 at a rightmost end of the substrate 150 as denoted by point 0. The live device 450 is translated T (e.g., moved) across the surface 151 in increments of 25 mm denoted by M until it reaches the end of the substrate 150 as denoted by point N. At each increment along the path of translation T, the live device 450 is rotated R about an axis Y a full 360 degrees in increments of 45 degrees (e.g., eight increments). The RF transmission Tx 453 from live device 450 is received as RF signal Rx 453 by the antenna 100 and stimulates the antenna 100 to generate a signal that is detected by RF system 160. A signal generated by RF system 160 on its output 169 may be measured (e.g., using test equipment) to determine RF signal strength received by antenna 100 from the live device 450 at different increments of angular rotation R and translation distance T along the substrate 150 (e.g., from 0 to N=250 mm). Accordingly, while the live device 450 is placed at position 0, eight measurements may be taken for angular increments of 0 deg, 45 deg, 90 deg, 135 deg, 180 deg, 225 deg, 270 deg, and 325 deg. Those measurements may be repeated for each 25 mm increment along the translation path T. The above mentioned increments are non-limiting examples and other increments may be used.

In the cross-sectional view of FIG. 4B, live device 450 is depicted in its most preferred placement, which is directly on the surface 151 of substrate 150. However, in some applications the live device 450 may be placed above the surface 151 at a distance 470 that is in very close near field proximity of the surface 151 of the substrate 150 and its associated antenna 100 and passive slits (101, 103). Although the received RF signal Rx 453 may be at its strongest when the live device is at 470=0 (e.g., directly on surface 151), there may be circumstances where the live device is positioned in very close near field proximity of the surface 151. In the very near field region, the drop off or RF signal strength may be larger than the well understood 1/R² drop off rate, and the drop off may be 1/R³ or 1/R⁴. Therefore, even small distances from surface 151 may result in a large drop off in RF signal strength as received by antenna 100 and detected by RF system 160. Distance 470 is preferably 0.5 meters or less, more preferably 50 mm or less, and even more preferably 30 mm or less. Actual distances for very close near field proximity will be application dependent and are not limited to the examples described herein. The live device 450 may comprise a wide variety of wirelessly enabled devices including but not limited to a smartphone, gaming device, tablet or pad, wireless headset or earpiece, a laptop computer, an image capture device, a wireless wristwatch or timepiece, a data capable strapband or wristband, just to name a few.

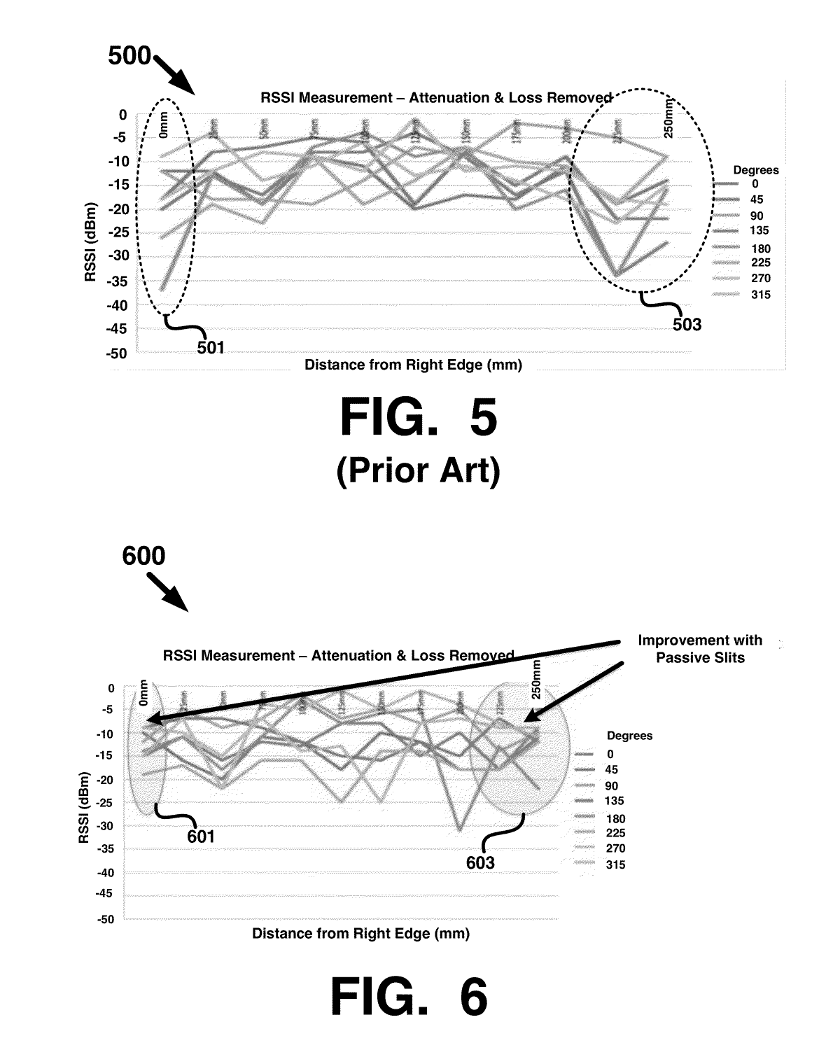

Attention is now directed to FIG. 5 which depicts a plot 500 of RSSI measurements for a conventional system that uses an antenna and does not use passive slits. On a y-axis of plot 500, a received signal strength indication (RSSI) is measured in units of dBm and on an x-axis distance from a right edge of a substrate of electrically conductive material that only has a single aperture that defines a single antenna. The substrate sans the passive slits RSSI loss below −20 dBm at the 0 mm position at the right most edge of the substrate as denoted by the region 501 in dashed line. Here, at 0 mm when the live device is rotated about its axis to the 180 degree and 225 degree positions, the RSSI is below −35 dBm at 180 degrees and is below −25 dBm at 180 degrees. Similarly, in region 502 between the 225 mm and 250 mm positions near the left end of the substrate, at the 225 mm position the 0 degree and 180 degree rotational positions result in RSSI that is almost at −35 dBm. At the 250 mm position, the 0 degree rotational position yields a RSSI that about below −27 dBm.

Looking now at FIG. 6, an improvement in RSSI at the 0 mm, 225 mm and 250 mm positions on the substrate 150 that includes the antenna 100 and the passive slits (101, 103), as depicted in FIGS. 4A-4B, is shown. In FIG. 6, in a region 601 at the 0 mm position at the rightmost end of the substrate 150, for all angular rotations between 0 degrees and 315 degrees, measured RSSI does not fall below −20 dBm for any angular position of the live device 450. The measured RSSI shows an improvement of approximately 17 db for the 180 degree position and approximately 6 dB for the 225 degree position when compared to the conventional no-passive slit configuration plotted in FIG. 5. In a region 503, at the 225 mm and 250 mm positions towards the leftmost end of the substrate 150, for all angular rotations between 0 degrees and 315 degrees, measured RSSI does not fall below −25 dBm for any angular position of the live device 450. At the 180 degree rotation at the 225 mm position, RSSI improved by approximately −20 dBm. At the 180 degree rotation at the 250 mm position, RSSI decreased by approximately 7 dB at just slightly below the 20 dBm line on the plot. At the 0 degree rotation at the 225 mm position, the RSSI improved by approximately 15 dB, and at the 250 mm position the RSSI improved by approximately 5 dBm.

The live device when placed directly on top of the substrate of FIG. 5 shows a larger positional dependency at the right and left ends of the substrate as highlighted in the regions 501 and 503. Therefore, a user who places his/her live device at the ends of the substrate may not have the RF signal emitted by the live device be detected by the substrate having only the antenna. Accordingly, the user may have to consciously avoid certain portions and angular orientations of the live device on the substrate in order to get accurate detections of RF emissions from the live device.

Ideally, the most straight forward and easy to remember use scenario for a user may be a simple instruction to place the live device 450 anywhere on the surface 151 of the substrate 150 regardless of angular orientation of the live device, in order to have the RF emissions from the users device detected by the antenna 100 used in conjunction with the passive slits (101, 103). The plot 600 of FIG. 6 and the depictions in FIGS. 4A-4B improve measured RSSI and allow for reduction or elimination of placement errors that may lead to low RSSI and failure to detect a live device 450 even thou it has been placed directly on the surface 151 of the substrate 150.

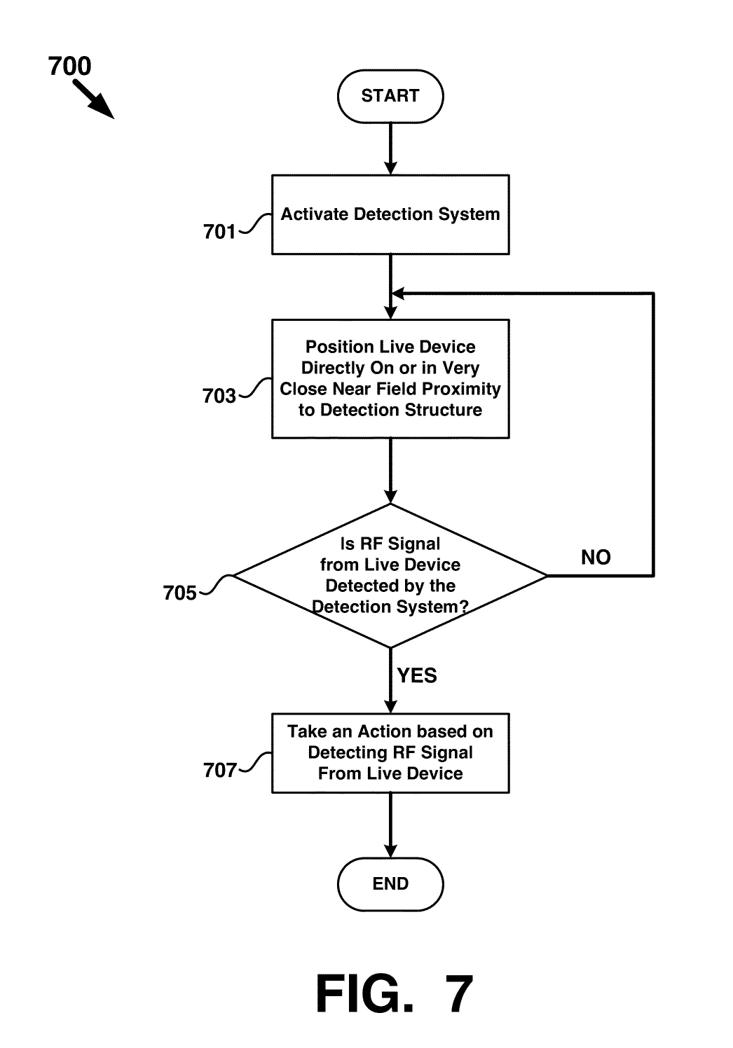

FIG. 7 depicts a flow diagram 700 for detecting a live device (e.g., device 450) using a system having an antenna 100 and one or more passive slits (101, 103). At a stage 701 a detection system is activated. The detection system may comprise the substrate 150 and its corresponding antenna 100, passive slits (101, 103), and RF system 160. Activation may comprise powering up or signaling a system or portions of the system that includes the detection system. Activation places the system in readiness to detect RF signals from live devices placed on or in very close near field proximity of the substrate 150. At a stage 703 a live device is positioned directly on or in very close near field proximity to the detection system. At a stage 705 a determination may be made by the detection system or other system as to whether or not a RF signal from the live device has been detected by the detection system (e.g., RF system 160). If no RF signal is detected, then a NO branch may be taken back to a prior stage, such as the stage 703 to retry the process. If the RF signal is detected by the detection system, then a YES branch may be taken to a stage 707. At the stage 707 an action may be taken based on having detected the RF signal. The action that is taken will be application dependent. The action taken may be implemented using circuitry, hardware, software fixed in a non-transitory computer readable medium, or any combination thereof. As one example, the action taken may be to signal the RF system to activate a RF transceiver into a sniffing mode to begin sniffing packets from WiFi devices. WiFi devices having the strongest RSSI above a predetermined threshold (e.g., the live device 450 because it is right on top of the detection system) may be selected for further analysis, while others with WiFi devices below the threshold may be ignored. As another example, the action may comprise establishing wireless link with the live device and transferring content handling from the live device to a system or device that incorporates or uses the detection system. In some applications, the action taken may be to have the live device and a system/device that includes the RF system 160 and antenna 100 to use the antenna 100 to both Tx and Rx with the live device while the live device is still positioned directly on top of substrate or within near or very near field proximity, for example. Data that may be communicated during the Tx and Rx may include but is not limited to: wireless network names and passwords, user names and passwords necessary to access content the live device will hand over to the system/device for handling; locations (e.g., in data storage or the Cloud) for playlists and/or content, just to name a few. Antenna 100 may be used to Tx at a very low power level so that other RF systems positioned beyond the near field region (e.g., >1 meter) may not be able to detect the transmissions from antenna 100 due to low signal strength.

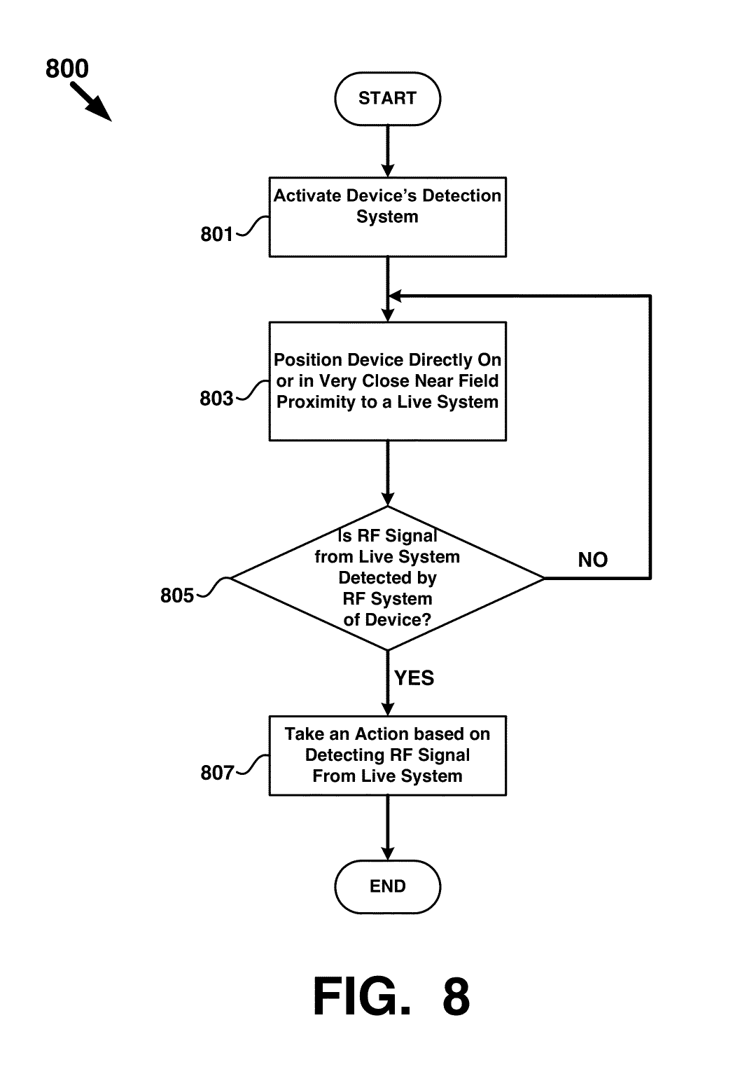

FIG. 8 depicts a flow diagram 800 for detecting a live system using a device having an antenna 100 and one or more passive slits (101, 103). At a stage 801a device's detection system is activated. For example, the detection system may be includes in user device such as a smartphone, tablet, or pad, just to name a few. The user device may include the detection system having the substrate 150 and its corresponding antenna 100, passive slits (101, 103), and RF system 160. At a stage 803 the device (e.g., a user device) is positioned directly on or in very close near field proximity of a live system. The live system may be any device, system or apparatus that generates, communicates, or networks using RF signals that may be detected and acted on by the device (e.g., a user device). At a stage 805, a determination may be made by the detection system or other system as to whether or not a RF signal from the live system has been detected by the detection system. If no RF signal is detected, then a NO branch may be taken back to a prior stage, such as the stage 803 to retry the process. If the RF signal is detected by the detection system, then a YES branch may be taken to a stage 807. At the stage 807 an action may be taken based on having detected the RF signal. The action that is taken will be application dependent. The action taken may be implemented using circuitry, hardware, software fixed in a non-transitory computer readable medium, or any combination thereof. As one example, the action taken may be to allow access to some structure or property such as an automobile, a garage, a door, a vault, a safe, an elevator, a turn style, an electronic device or system, a kiosk, just to name a few. The action taken may be similar to or identical to the actions described above for flow 700 of FIG. 7.

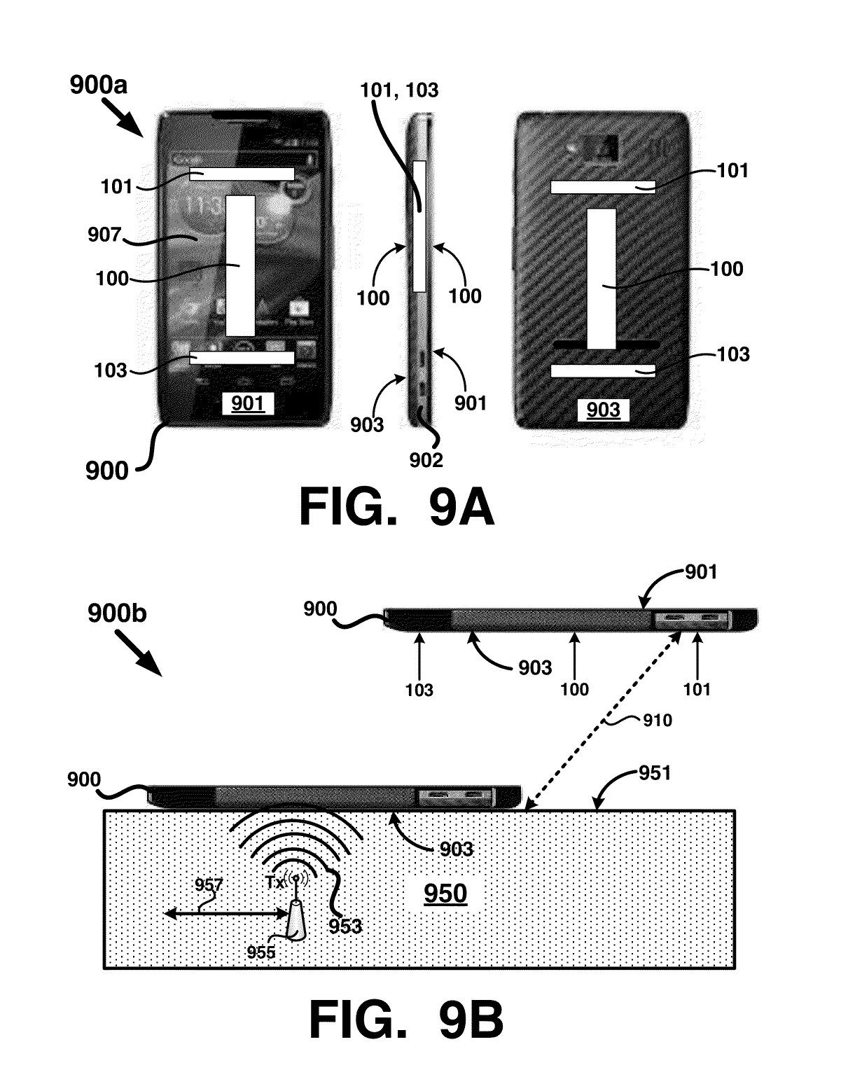

FIG. 9A depicts front, side, and back views of a device 900 that includes an antenna 100 and one or more passive slits (101, 103) and may be used for the device (e.g., user device) described above in flow 800 of FIG. 8. The antenna 100 and one or more passive slits (101, 103) may be positioned on a front side 901 of device 900, a back side 903, a side 902, or some combination thereof. If the side 902 is not big enough to accommodate all of the elements of the detection system, such as both the antenna 100 and the passive slits (101, 103), then at least some of those elements may be positioned on the side 902, such as the antenna 100.

A display 907 on front side 901 of device 900 may be configured to include the antenna 100 and one or more passive slits (101, 103) formed in an optically transparent and electrically conductive electrode material printed or otherwise formed on the display 907. Appropriate electrical connections between the opposed edges of the antenna 100 may be made to the RF system and ground potential as described above. The back side 903 of the device 900 may be configured to include the antenna 100 and one or more passive slits (101, 103) formed on an appropriate electrically conductive material for the substrate (e.g., substrate 150). Similarly, an appropriate material may be used to form antenna 100, the passive slits (101, 103), or both on the sides 902 of device 900. In some examples, the antenna 100 and one or more passive slits (101, 103) may be formed on multiple sides of the device 900, such as the front 901 and the back 903.

FIG. 9B depicts the device 900 of FIG. 9A being positioned 910 directly on top of a live system 950. Here, back side 903 of device 900 is positioned directly on a surface 951 of the live system 950 which is actively transmitting Tx and RF signal 953 from an antenna 955 that is electrically coupled 957 with a RF system (not shown) of the live system 950. When positioned directly on top of the live system 950, the antenna 100, and the passive slits (101, 103) on the back side 903 are positioned to detect the RF signal 953.

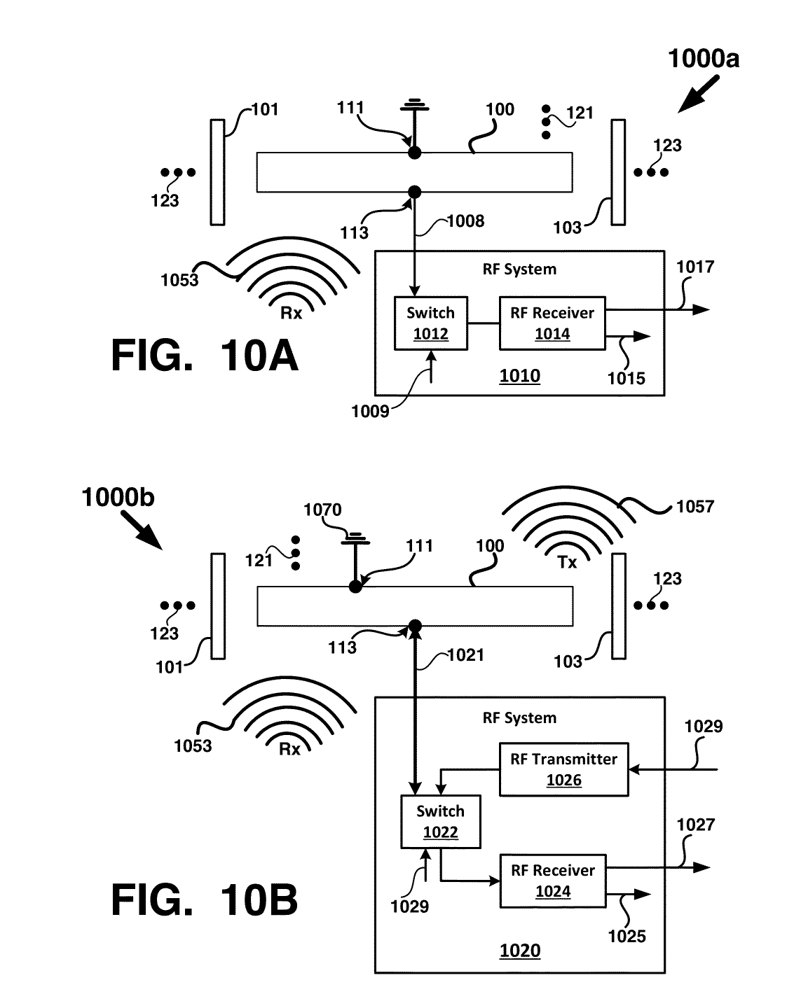

FIG. 10A depicts a schematic diagram 1000a of one example of an antenna 100 electrically coupled with a RF system 1010. RF system 1010 may optionally include a switch 1012 that in response to a signal 1009 may connect or disconnect the antenna 100 from a RF receiver 1014. The RF system 1010 may not include the switch 1012, in which case, the antenna 100 may be directly coupled with the RF receiver 1014. RF receiver 1014 may generate a signal 1015 internal to RF system 1010, a signal 1017 external to RF system 1010, or both in response to signals generate by RF signals Rx 1053 received by or incident on antenna 100. A computer system such as that described above in reference to FIG. 2 may take some action based on one or more of the signals (1015, 1017). FIG. 10A depicts one example of a receive only mode for the antenna 100.

FIG. 10B depicts a schematic diagram 1000b of another example of an antenna 100 electrically coupled with a RF system 1020. Here, antenna 100 is electrically coupled with a switch 1022 that is responsive to one or more signals 1029 that activate the switch 1022 to couple the antenna 100 with a RF receiver 1024 configured to detect signals caused by RF signals Rx 1053 received by or incident on antenna 100, or to couple antenna 100 with a RF transmitter 1026 configured to receive a signal 1029 and to cause the antenna 100 to transmit RF signal Tx 1057 based on the signal 1029. RF receiver 1024 may generate a signal 1025 internal to RF system 1020, a signal 1027 external to RF system 1020, or both in response to signals generate by RF signals Rx 1053 received by or incident on antenna 100. A computer system such as that described above in reference to FIG. 2 may take some action based on one or more of the signals (1025, 1025) and may generate the signal 1029 to be transmitted by antenna 100. In FIGS. 10A-10B, although one antenna 100 is depicted there may be a plurality of antennas 100 as denoted by 121 and although two passive slits (101, 103) are depicted there may be just a single passive slit or more than two passive slits as denoted by 123.

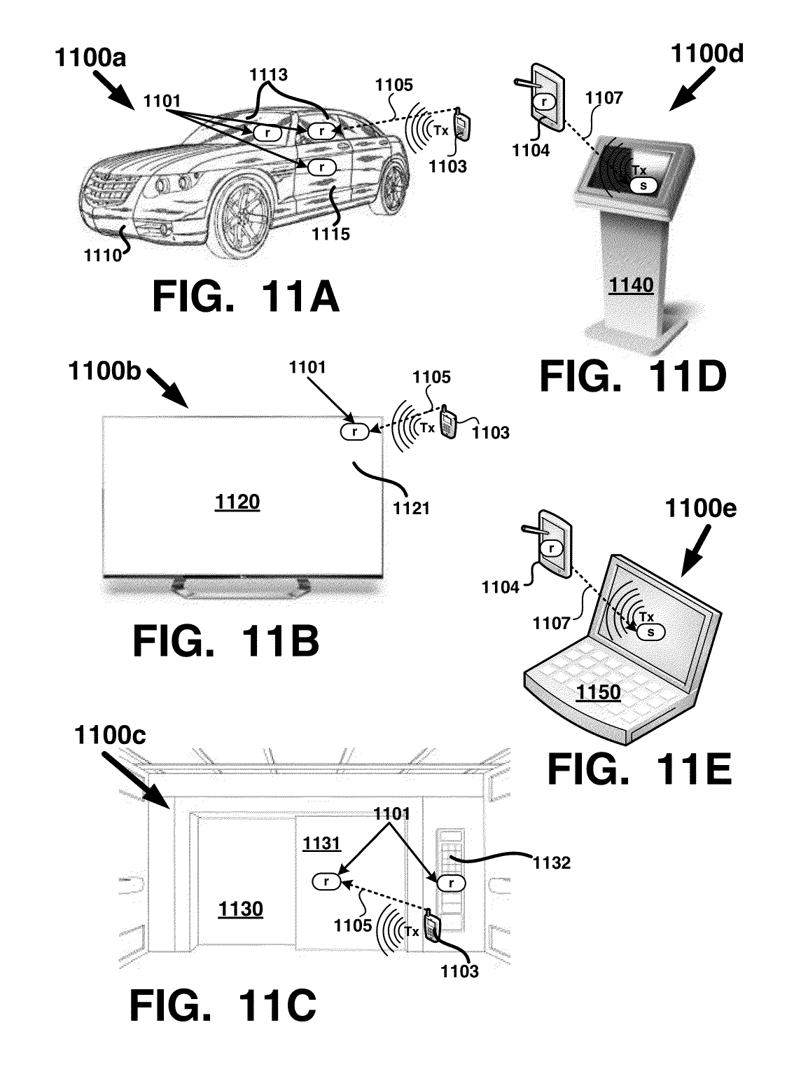

FIGS. 11A-11E depict different use examples 1100a-1100e for the antenna/passive slit detection systems described above. In FIGS. 11A-11E, actions may be taken by detection systems, live systems, live devices, or any combination of the aforementioned. In FIG. 11A a vehicle 1110 may include a detection system denoted as R positioned at various locations on the vehicle 1110. The detection system in R may comprise the antenna 100, the passive slits (101, 103) and the RF system 160. A live device 1103 is transmitting Tx a RF signal and is positioned 1105 in direct or in very close near field proximity to detection system R, causing one or more actions to be taken, such as unlocking the vehicle, starting the vehicle, arming/disarming the alarm on the vehicle, causing content handling on live device 1104 to be transferred to a system of the vehicle, just to name a few. The detection system R may be disposed on a door, glass or plastic surface of the vehicle 1110 or some other structure, such as a windshield, a door, door glass, a dashboard, a door panel, a console, for example.

In FIG. 11B, the detection system R may be incorporated into a display 1121 of a smart TV 1120 and a live device 1103 when positioned 1105 in direct or in very close near field proximity to detection system R cause one or more actions to be taken by smart TV 1120 such as turning the smart TV 1120 on, allowing live device 1103 to control the smart TV 1120 (e.g., as a remote control), or causing the handling of content to be transferred from live device 1103 to the smart TV 1120, for example.

In FIG. 11C, the detection system R may be incorporated into a door 1131 or control panel 1132 of an elevator 1130 or similar conveyance. A live device 1103 when positioned 1105 in direct or in very close near field proximity to detection system R cause one or more actions to be taken by elevator 1130, such as allowing access to the elevator 1130, handshaking with the live device 1103 to determine which floor the elevator will transport a user to, transferring maintenance information/records from the elevator 1130 to the live device 1103, for example.

In FIG. 11D, a kiosk 1140 includes a live system S that transmits Tx a RF signal and device 1104 includes a detection system R that when positioned 1107 in direct or in very close near field proximity to live system S cause an action to be taken by the kiosk 1140, the device 1104, or both. For example, the action may be to cause the kiosk 1140 to print a ticket or boarding pass, to wirelessly transfer a ticket or boarding pass in digital form to the device 1104, download or transfer content/information from the kiosk 1140 to the device 1104, to allow access to a restricted area, transfer wireless network access information to the device 1104, just to name a few.

In FIG. 11E, a laptop 1150 includes a live system S that is transmitting Tx an RF signal. Device 1104 includes a detection system R that when positioned 1107 in direct or in very close near field proximity to live system S cause an action to be taken by the laptop 1150, the device 1104, or both. Here, the action taken my be to download images from the device 1104 to a storage system on the laptop 1150, to unlock or wake up the laptop 1150, cause the laptop to shut down or logoff for security purposes, cause the laptop 1150 to download content from the Internet based on a list stored in the device 1104, just to name a few. The examples depicted in FIGS. 11A-11E are non-limiting examples and the detection system R may be included in a variety of systems, devices, and structures such as a structure operative as a table, desk, counter, cabinet, window, a display screen, just to name a few.

The material for the substrate 150 may include any electrically conductive material including but not limited to metals, metal alloys, electrically conductive films, paints, and inks, PC boards, flexible PC boards, electrically conductive materials that can be printed on, painted on, screen printed on or otherwise formed or deposited on a substrate. The separate apertures for the antenna 100 and passive slits (101, 103) may be formed by process including but not limited to etching, milling, cutting, sawing, drilling, punching, stamping, laser cutting, high pressure water cutting, just to name a few.

The antenna 100 or antennas 100 may be an active antenna, a passive antenna or both. An active antenna 100 may be electrically couple with circuitry in a radio, RF system or other electrical system for driving the active antenna to generate a RF signal comprised of an electromagnetic wave (EM wave) or to electrically couple a received signal that is generated by a RF signal incident on the active antenna with the circuitry. In some applications antenna 100 may be switchable (e.g., via circuitry coupled with antenna 100) between an active mode of use and a passive mode of use, where the antenna 100 is an active antenna when the active mode is enabled and is a passive antenna when the passive mode is enabled, for example. In some examples, a plurality of antennas 100 may be configured such that a portion of the plurality are configured as active antennas and another portion of the plurality are configured as passive antennas. In other examples, a plurality of antennas 100 may be configured such that at least a portion of the plurality are switchable between the active mode and passive mode as described above.

The antenna 100 when configured as an active antenna may be configured to transmit RF signals, receive RF signals or both. The antenna 100 when configured as a passive antenna may be configured to only receive RF signals. The antenna 100 when configured (e.g., via switching) as an active antenna in the active mode and as a passive antenna in the passive mode may be configured to transmit RF signals, receive RF signals or both. In some applications, circuitry electrically coupled with antenna 100 may operate to determine if antenna 100 is an active antenna or a passive antenna, for example. In other applications, a switch (e.g., a multiplexer or other circuitry) electrically couples antenna 100 with first circuitry configured to operate antenna 100 as an active antenna and second circuitry configured to operate antenna 100 as a passive antenna. The switch may select between the first circuitry and the second circuitry in response to a select signal or the like (e.g., select=logic 0 selects the first circuitry and select=logic 1 selects the second circuitry). In yet other applications, a switch (e.g., a multiplexer or other circuitry) electrically couples antenna 100 with first circuitry configured to operate antenna 100 as an active antenna and no circuitry at all (e.g., a wire or conducive trace) to operate antenna 100 as a passive antenna. In other examples, the switch may select between the first circuitry, the second circuitry, and no circuitry. Active and/or passive antennas may be used in a variety of configurations and the above are non-limiting examples of possible configurations. Referring back to FIGS. 10A-10B, switches (1012, 1022) and circuitry (1014, 1026, 1024) in RF systems 1010 and 1020 are two non-limiting examples of switches that may select (e.g., via 1009 or 1029) between circuitry that is electrically coupled with antenna 100.

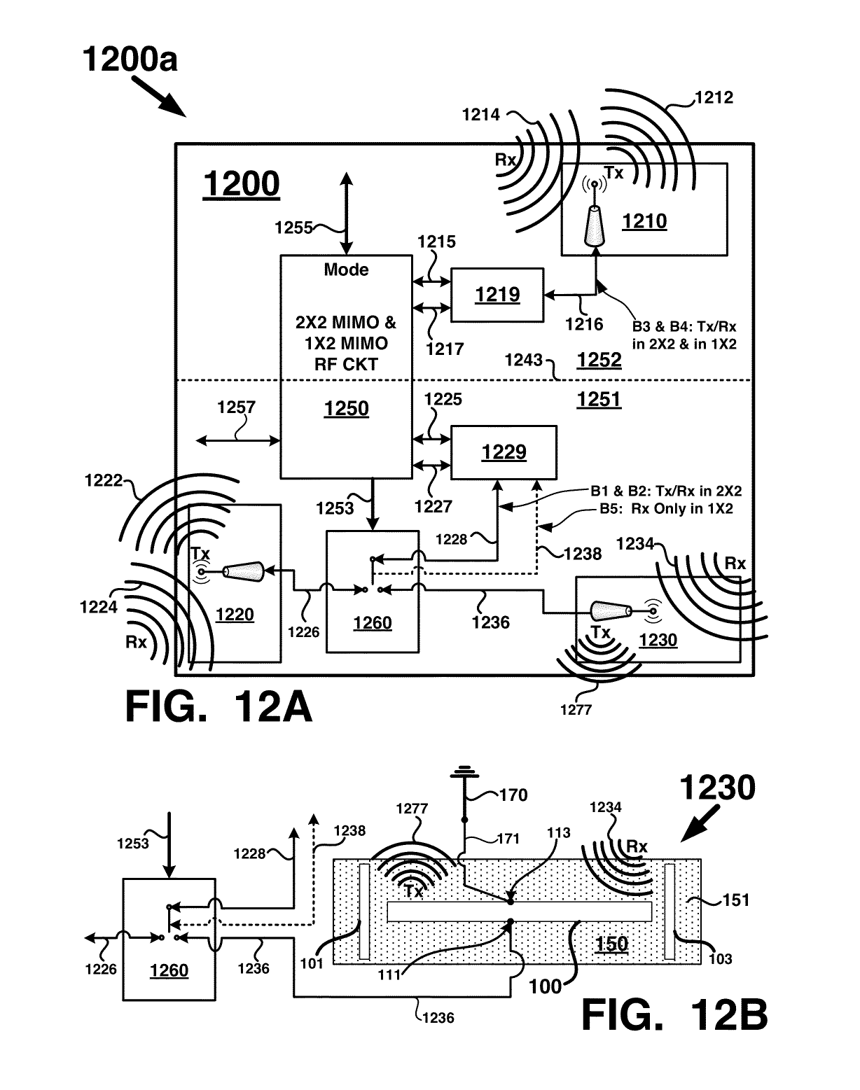

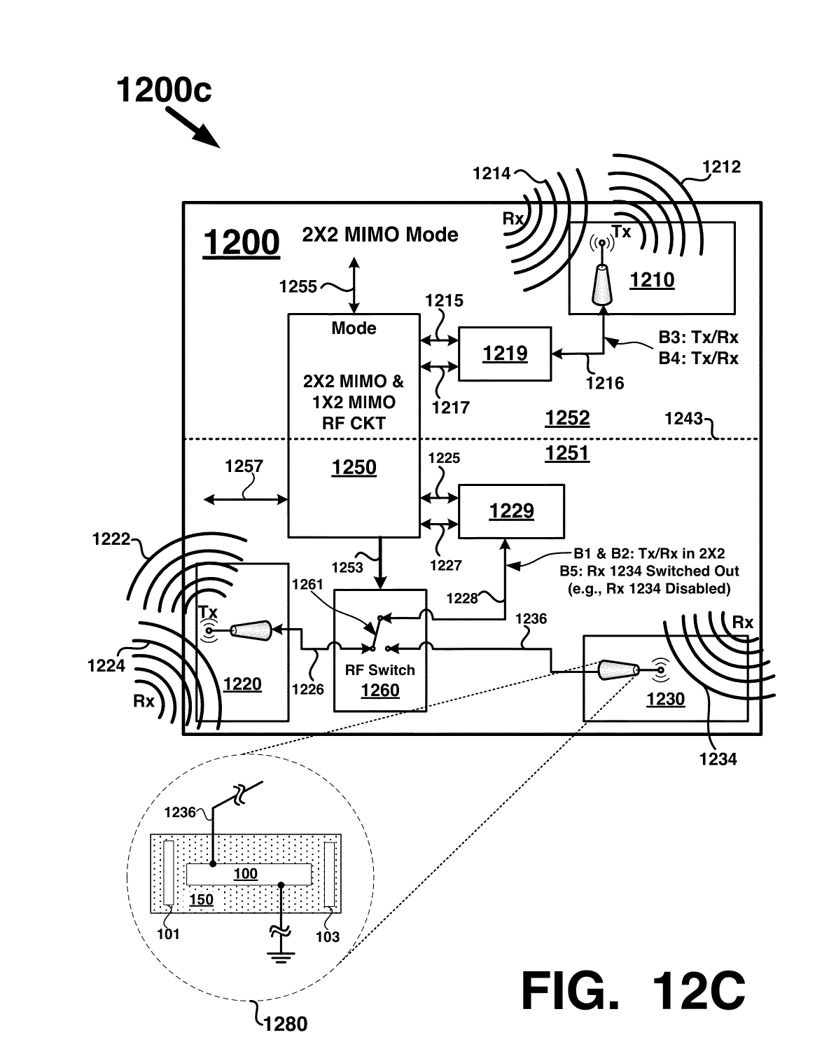

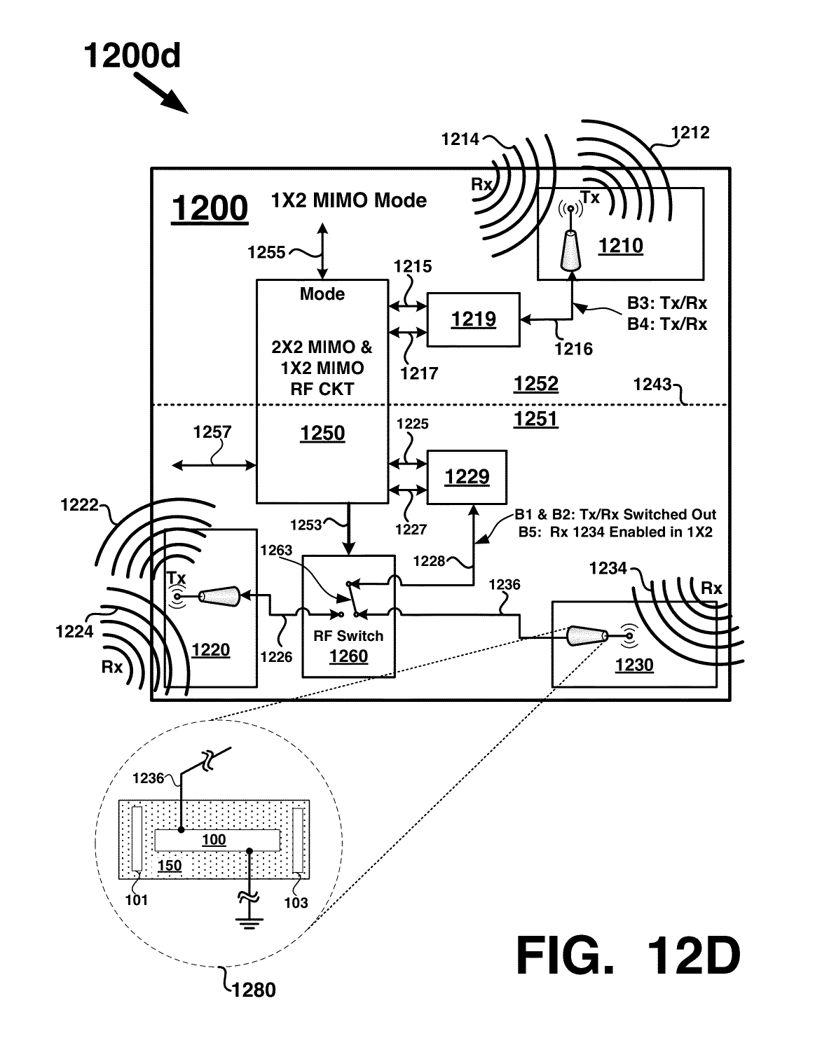

Attention is now directed to FIG. 12A where a block diagram 1200a depicts one example of a RF frontend architecture 1200 (RF 1200 hereinafter). Unless otherwise stated, elements in RF 1200 may be implemented using a variety of technologies including but not limited to an integrated circuit (IC), a mixed-signal IC, an application specific integrated circuit (ASIC), a mixed signal ASIC, discrete electronic components, combinations of discrete electronic components and IC's or ASIC's, just to name a few. RF 1200 includes RF circuitry 1250 having circuitry for a 2×2 Multiple-Input Multiple-Output (MIMO) and a 1×2 MIMO. One or more signals (e.g., 1257, 1255), either internal to RF 1200, external to RF 1200, or both may be used to set a 2×2 MIMO mode or 1×2 MIMO mode. For example, a mode signal 1255 received by RF circuitry 1250 may be used to determine with of the two MIMO modes is set. As one example, if the mode signal 1255 is active high, then the 2×2 MIMO mode is set, and if the mode signal 1255 is active low, then the 1×2 MIMO mode is set. In other examples, another signal or group of signals may set the MIMO mode or cause the mode signal 1255 to be set to one of the two MIMO modes. For example, one or more signals on port 1257 of RF circuitry 1250 may be used to set the MIMO state or cause the mode signal 1255 to be set to a particular value or voltage level (e.g., logic 1 or logic 0).

RF circuitry 1250 may include two separate RF chains and their associated circuitry and antennas. For purposes of explanation, a dashed line 1243 will be used to visually demark a first RF chain 1251 from a second RF chain 1252 so that the functionality of the two RF chains may be described with clarity. In the first RF chain 1251, circuitry 1229 may be electrically coupled (1225, 1227) with RF circuitry 1250 and a RF switch 1260. Connections 1225 and 1227 may be for ports on RF circuitry 1250 that support different RF bands such as 2.4 GHz, 5 GHz, and Bluetooth (BT), for example. Connections 1225 and 1227 may also be used to couple RF signals such as those associated with antenna 1230 as will be described below. RF chain 1251 may include two antennas such as antenna 1220 and antenna 1230, both of which are electrically coupled (1226, 1236) with RF switch 1260. RF switch 1260 may select between antennas 1220 and 1230 based on a signal 1253 received by the switch 1260 from RF circuitry 1250. Antenna 1220 may be a dual band antenna or a dual band chip antenna. The dual band chip antenna may be monolithically integrated with a semiconductor die that include some or all of the circuitry in RF 1200 and/or RF circuitry 1250. The dual band chip antenna may be positioned (e.g., floor planned) at a specific location on the die such as at a corner or a side of the die. There may be multiple dual band chip antennas and those antennas may be positioned at opposing corners of the die or at opposing sides or edges, for example. Antenna 1230 may be an antenna specifically configured for proximity detection of external sources of RF signals (e.g., for near field detection such as NFC or the like). For example, antenna 1230 may be a proximity detection antenna configured to generate a RF signal on 1236 when a transmitting RF device is placed directly on or in contact with antenna 1230, or positioned in near field proximity or very close near field proximity of antenna 1230. Very close near field proximity may comprise a distance from the antenna 1230 that is approximately 0.5 meters or less. More preferably, 50 mm or less. Even more preferably, 30 mm or less. Near field proximity may comprise a distance that is greater than 0.5 meters. The foregoing are non-limiting examples of what may define near field proximity or very close near field proximity and actual values will be application dependent. Antenna 1230 may be configured to be intentionally detuned (e.g., to a lower frequency) from a target frequency, such as the frequency or frequencies of the external sources of RF signals and/or one or more of the dual band frequencies of RF 1200. As will be described below in regard to FIG. 12B, antenna 1230 may be configured as the antenna 100 on substrate 150 and having passive slits (101, 103) as described above. For example, if the target frequency is 2.4 GHz, then antenna 1230 may be detuned to a lower frequency that may be approximately in a range from about 0.5 GHz to about 1.0 GHz. Antenna 1230 will be described in greater detail below. Examples of target frequencies include but are not limited to: 2.4 GHz; 2.4 GHz-2.48 GHz; from about 2.4 GHz to about 2.48 GHz; 5 GHz; unlicensed bands, licensed bands, cellular bands, bands used by 2G, 3G, 4G, and 5G devices, Bluetooth bands, any of the IEEE 802.11 bands, military bands, just to name a few. Antenna 1230 may be tuned to the target frequency or in some examples may be detuned to a frequency range that is below that (i.e., lower) of the target frequency or to a frequency range that is above (i.e., greater) that of the target frequency. In some examples, one or more dimensions (e.g., length and width) of the antenna 100 are larger than one or more dimensions of the passive slits (101, 103). For example, the antenna 100 may have a length dimension and a width dimension that are larger than width and length dimensions of the passive slits (101, 103). In other examples, an area on the substrate 150 occupied by the antenna 100 (e.g., regardless of dimensions of antenna 100) is larger than an area on the substrate 150 occupied by one or more of the passive slits (101, 103).

RF chain 1252 includes circuitry 1219 that may be electrically coupled (1215, 1217) with RF circuitry 1250. Connections 1215 and 1217 may be for ports on RF circuitry 1250 that support different RF bands such as 2.4 GHz, 5 GHz, and Bluetooth (BT), for example. RF chain 1252 may include an antenna 1210 that may be a dual band antenna or a dual band chip antenna as described above for antenna 1220. RF circuitry 1250 may support multiple MIMO modes, such as a 2×2 MIMO mode and a 1×2 MIMO mode and RF circuitry 1250 may reversibly switch between the multiple MIMO modes, such as between 2×2 MIMO and 1×2 MIMO modes (e.g., in response to signal 1255 and/or 1257). When the 2×2 MIMO mode is set, RF circuitry 1250 is configured for dual band RF communication for both transmit (Tx) and receive (Rx) using both antennas (1210, 1220). Moreover, the dual band RF communications may occur simultaneously such that RF chain 1251 may use its antenna 1220 to Tx/Rx on dual RF bands, such as WiFi 2.4 GHz and/or WiFi 5 GHz or Bluetooth and/or WiFi 5 GHz. Similarly, RF chain 1252 may use its antenna 1210 to Tx/Rx on dual RF bands, such as WiFi 2.4 GHz and/or WiFi 5 GHz or Bluetooth and/or WiFi 5 GHz. RF circuitry 1250 may be configured so both of the RF chains (1251, 1252) may Tx/Rx using Bluetooth, or only one of the RF chains (1251, 1252) may Tx/Rx using Bluetooth (e.g., BT on RF chain 1252 only). Ports 1215, 1217, 1225, and 1227 may be configured for different frequency bands. For example, ports 1215 and 1225 may be assigned for a RF band such as 2.4 GHz, and ports 1217 and 1227 may be assigned to another RF band such as 5 GHz. In some applications, all of the ports (1215, 1217, 1225, and 1227) may be simultaneously Tx/Rx RF signals over their respective RF bands and in other application some or all of the ports (1215, 1217, 1225, and 1227) may be idle. Actual port traffic may be determined by a system or device that incorporates RF 1200.

In FIG. 12B, one example of antenna 1230 may comprise the antenna 100 (e.g., as described above) and its associated passive slits (111, 113) formed on substrate 150 with node 113 electrically coupled 171 to GND 170 and node 111 electrically coupled 1236 with RF switch 1260 when so selected by a select signal on 1253. Antenna 100 may be configured to receive only RF signals 1234 and may be operative to generate a signal on 1236 that is electrically coupled with circuitry 1229 and 1250 when the RF switch 1260 selects antenna 1230. In the configuration depicted, antenna 100 may be a passive (e.g., a receive Rx 1234 only mode) antenna as described above. However, the present application is not limited to a passive configuration for antenna 1230 (e.g., antenna 100) and RF 1200 may include circuitry (e.g., in 1250) configured to drive a signal on antenna 1230 (e.g., antenna 100) in an active mode of operation of antenna 1230 (e.g., antenna 100). In active mode, antenna 1230 (e.g., antenna 100) may transmit Tx 1277 RF signals. A plurality of antennas (e.g., antenna 100) may be electrically coupled with RF 1200 (e.g., via RF switch 1260) and at least a portion of the plurality of antennas may be configured as transmit only, receive only, transmit and receive, active only, passive only, or active and passive, just to name a few. RF switch 1260 may selectively switch (e.g., via bus 1253) between a plurality of antennas coupled with RF switch 1260.

Referring back to FIGS. 4A-4B, proximity detection antenna 1230 (e.g., antenna 100) may be configured to detect an RF signal (e.g., Tx 453) from an external device (e.g., device 450) as was described above. In some examples, proximity detection antenna 1230 (e.g., antenna 100) may be configured to transmit Tx (not shown) an RF signal to an external device. The transmitting Tx the RF signal to the external device may occur subsequent to the external device first being detected in proximity distance range of proximity detection antenna 1230 (e.g., antenna 100) as depicted in FIG. 4B, for example.

### 2×2 MIMO Mode

In FIGS. 12A and 12C, for purposes of explanation, assume mode signal 1255 is set to the 2×2 MIMO mode as depicted in example 1200c of FIG. 12C. In the 2×2 MIMO mode, RF switch 1260 electrically couples 1261 the antenna 1220 with circuitry 1229 and dual bandwidth RF communication using antenna 1220 is enabled such that dual RF bands denoted as B1 and B2 may both simultaneously Tx 1222 and Rx 1224 RF signals via electrical coupling 1228 between circuitry 1229 and antenna 1220. Here B1 may be associated with port 1225 and B2 with port 1227. While in the 2×2 MIMO mode, antenna 1230 is electrically decoupled from circuitry 1229 by switch 1260. Antenna 1230 may be tuned to a fifth RF signal denoted as Rx 1234. However, in the 2×2 MIMO mode, if Rx 1234 is incident on antenna 1230, then a resulting signal is not electrically coupled 1236 with circuitry 1229 because RF switch 1260 is set to electrically couple 1261 with antenna 1220 thereby switching out B5 for Rx 1234. Furthermore, while in the 2×2 MIMO mode the circuitry 1219 is electrically coupled with antenna 1210 and dual RF bands denoted as B3 and B4 may both simultaneously Tx 1212 and Rx 1214 RF signals via electrical coupling 1216 between circuitry 1219 and antenna 1210. Therefore, four RF bands (B1-B4) may be active for Tx and Rx in the 2×2 MIMO mode and RF signal reception over B5 is blocked because antenna 1230 is switched out.

### 1×2 MIMO Mode

Moving now to FIG. 12D, for purposes of explanation, assume mode signal 1255 is set to the 1×2 MIMO mode as depicted in example 1200d of FIG. 12D. In the 1×2 MIMO mode, RF switch 1260 electrically couples 1263 the antenna 1230 with circuitry 1229 and dual bandwidth RF communication (B1, B2) using antenna 1220 is disabled because the antenna 1220 is switched out. Here, when antenna 1230 has Rx 1234 incident on it a signal may be electrically communicated (1236, 1238) to circuitry 1229 and that signal may be processed by RF circuitry 1250 or other. The processing may be used to determine relative signal strength based on the signal, or to make received signal strength indicator (RSSI) measurements based on the signal. Furthermore, while in the 1×2 MIMO mode the circuitry 1219 is electrically coupled with antenna 1210 and dual RF bands (B3, B4) and both bands may simultaneously Tx 1212 and Rx 1214 RF signals via electrical coupling 1216 between circuitry 1219 and antenna 1210. Therefore, two RF bands (B3-B4) may be active for Tx and Rx in the 1×2 MIMO mode in RF chain 1252 and RF signals may be received only in RF chain 1251 via antenna 1230. Tx and Rx over B1 and B2 is blocked in the 1×2 MIMO mode because antenna 1220 is switched out. As depicted in detailed view 1280 of FIGS. 12C and 12D, antenna 1230 may comprise the antenna 100 of FIG. 12B, with the RF switch 1260 selecting the antenna 100 in FIG. 12D in 1×2 MIMO mode thereby enabling proximity detection of RF signals using antenna 100 (e.g., Enabling reception of RF signals Rx 1234), and the RF switch 1260 not selecting antenna 100 in FIG. 12C in the 2×2 MIMO mode such that antenna 100 is switched out (e.g., reception of RF signals Rx 1234 is Disabled) and not coupled with circuitry 1229 and/or 1250, for example. In some examples, RF 1200 may be configured to switch in or switch out antenna 1230 (e.g., antenna 100) from circuitry 1229 and/or 1250 or other circuitry for Rx 1234, Tx 1277, or both. In other examples, antenna 1230 (e.g., antenna 100) may be configured for proximity detection of RF signals Rx 1234 (e.g., in the near field, NFC, or other close proximity detection regime), for proximity transmission of RF signals Tx 1277 (e.g., for NFC or other near field communications regime), or both.

A more a more detailed block diagram of other examples of RF 1200 may include those depicted in FIGS. 1D-1F (e.g., 100e-100f) of U.S. patent application Ser. No. 13/957,337, filed on Aug. 1, 2013, having Attorney Docket No. ALI-233, and titled “RF Architecture Utilizing A MIMO Chipset For Near Field Proximity Sensing And Communication”, which is already incorporated by reference in its entirety for all purposes. In FIGS. 12C and 12D, the antenna 1230 may comprise the antenna 100 and passive slits (101, 103) formed on substrate 150 as described above. In some examples, RF 1200 may include circuitry (e.g., switch 1260) configured to electrically couple a plurality of the antennas 1230 depicted in FIG. 12B with circuitry 1250 or other. Therefore, the present application is not limited to a single antenna 1230 as depicted in FIG. 12B. One or more of the plurality of antennas 1230 as depicted in FIG. 12B may be configured to receive RF signals, transmit RF signals or both. One or more of the plurality of antennas 1230 as depicted in FIG. 12B may be configured to be a passive antenna, an active antenna, or both.

Table 1 below lists non-limiting examples of which bands (B1-B5) may Tx or Rx depending on the state of the MIMO mode signal.

TABLE 1

| Band | 2 × 2 MIMO Mode | 1 × 2 MIMO Mode |
|---|---|---|
| B1 | Tx and Rx on 120 | NO Tx or Rx on 120 |
| B2 | Tx and Rx on 120 | NO Tx or Rx on 120 |
| B3 | Tx and Rx on 110 | Tx and Rx on 110 |
| B4 | Tx and Rx on 110 | Tx and Rx on 110 |
| B5 | NO Rx on 130 | Rx only on 130 |

Table 2 below lists non-limiting examples of frequencies for bands (B1-B5) depending on the state of the MIMO mode signal.

TABLE 2

| Band | 2 × 2 MIMO Mode | 1 × 2 MIMO Mode |
|---|---|---|
| B1 | 2.4 GHz WiFi on 120 | NO Tx or Rx on 120 |
| B2 | 5 GHz WiFi on 120 | NO Tx or Rx on 120 |
| B3 | 2.4 GHz WiFi on 110 | 2.4 GHz WiFi on 110 |
| B4 | 5 GHz WiFi on 110 | 5 GHz WiFi on 110 |
| B1 | BT on 120 | NO Tx or Rx on 120 |
| B2 | 5 GHz WiFi on 120 | NO Tx or Rx on 120 |
| B3 | BT on 110 | BT on 110 |
| B4 | 5 GHz WiFi on 110 | 5 GHz WiFi on 110 |
| B5 | NO Rx on 130 | Rx** only on 130 |

Although Table 2 lists both B1 and B3 as being enabled for Bluetooth Tx and Rx, as was stated above, in some configurations, both B1 and B3 may Tx and Rx using Bluetooth, and in other configurations only B1 or B3 may Tx and Rx using Bluetooth. In some configurations B1, B3, or both may switch between Tx and Rx on 2.4 GHz WiFi to Tx and Rx on Bluetooth as needed. For example, in 2×2 MIMO mode, B1 may initially Tx and Rx over 120 using 2.4 GHz WiFi and then switch to Tx and Rx on Bluetooth when a BT enabled device is paired with or otherwise establishes a BT communications link with RF 100. While B1 continues to Tx and Rx on Bluetooth in the 2×2 MIMO mode, B3 may service the Tx and Rx 2.4 GHz WiFi traffic until B1 again becomes available for 2.4 GHz WiFi communications. The “**” in the column for 1×2 MIMO mode for B5 denotes that antenna 130 may be detuned for optimal performance at some frequency that is lower than those for (B1-B4) as described above.

The systems, wireless media devices, apparatus and methods of the foregoing examples may be embodied and/or implemented at least in part as a machine configured to receive a non-transitory computer-readable medium storing computer-readable instructions. The instructions may be executed by computer-executable components preferably integrated with the application, server, network, website, web browser, hardware/firmware/software elements of a user computer or electronic device, or any suitable combination thereof. Other systems and methods of the embodiment may be embodied and/or implemented at least in part as a machine configured to receive a non-transitory computer-readable medium storing computer-readable instructions. The instructions are preferably executed by computer-executable components preferably integrated by computer-executable components preferably integrated with apparatuses and networks of the type described above. The non-transitory computer-readable medium may be stored on any suitable computer readable media such as RAMs, ROMs, Flash memory, EEPROMs, optical devices (CD, DVD or Blu-Ray), hard drives (HD), solid state drives (SSD), floppy drives, or any suitable device. The computer-executable component may preferably be a processor but any suitable dedicated hardware device may (alternatively or additionally) execute the instructions.

As a person skilled in the art will recognize from the previous detailed description and from the drawing FIGS. and claims set forth below, modifications and changes may be made to the embodiments of the present application without departing from the scope of this present application as defined in the following claims.

Although the foregoing examples have been described in some detail for purposes of clarity of understanding, the above-described inventive techniques are not limited to the details provided. There are many alternative ways of implementing the above-described techniques or the present application. The disclosed examples are illustrative and not restrictive.

What is claimed is:

1. A device, comprising:
a substrate of electrically conductive material including a plurality of separate apertures formed in the substrate,
one or more of the plurality of separate apertures comprises an antenna having length dimension that is substantially larger than a width dimension, an edge of the aperture along the length dimension is electrically coupled with a radio frequency (RF) receiver and an opposing edge of the aperture along the length dimension is electrically coupled with a ground potential,
the length dimension is selected to detune the antenna at a frequency that is lower than a target frequency to be detected by the RF receiver, the length dimension being longer than a wavelength of the target frequency divided by two, and
a different one or more of the plurality of separate apertures comprises a passive slit that is not electrically coupled with the RF receiver or the ground potential.

2. The device of claim 1, wherein the antenna has a vertical polarization.

3. The device of claim 1, wherein a dielectric material is disposed in one or more of the plurality of separate apertures.

4. The device of claim 3, wherein the dielectric material comprises air.

5. The device of claim 1, wherein the passive slit has a length and a width that are less than the length dimension and width dimension, respectively of the antenna.

6. The device of claim 1, wherein different dielectric materials are disposed in at least two of the plurality of separate apertures.

7. The device of claim 1, wherein the target frequency comprises a frequency or frequency range selected from the group consisting of 2.4 GHz, 2.4 GHz-2.48 GHz, from about 2.4 GHz to about 2.48 GHz, 5 GHz, military frequency bands, unlicensed frequency bands, cellular frequency bands, and licensed frequency bands.

8. The device of claim 1, wherein the target frequency is in a range from about 2.4 GHz to about 2.48 GHz and the antenna is detuned to a range from about 0.5 MHz to about 1 GHz.

9. The device of claim 1, wherein the ground potential is a selected one of ground (GND) or a chassis ground.

10. The device of claim 1, wherein the substrate of electrically conductive material comprises at least a portion of a chassis or enclosure of an electrical device or system.

11. The device of claim 1 and further comprising:
a functional element, an esthetic element, or both, formed from an electrically non-conductive material and positioned in at least a portion of one or more the plurality of separate apertures.

12. The device of claim 1, wherein the substrate of electrically conductive material comprises a metal or a metal alloy.

13. The device of claim 1, wherein the substrate of electrically conductive material comprises a perforate material.

14. The device of claim 1 and further comprising at least two passive slits.

15. A multi-channel dual band wireless communication and radio frequency (RF) proximity detection system, comprising:
circuitry configured to implement a 2×2 Multiple-Input/Multiple-Output (MIMO) mode and a 1×2 MIMO mode, the circuitry configured to reversibly switch between the 2×2 MIMO mode and the 1×2 MIMO mode in response to a mode signal electrically coupled with a RF switch, the circuitry including
a first RF chain electrically coupled with the RF switch and configured, when the mode signal is set to the 2×2 MIMO mode, to be electrically coupled through the RF switch with a first dual band antenna and to transmit and receive first and second dual band RF signals using the first dual band antenna, and
configured, when the mode signal is set to the 1×2 MIMO mode, to be electrically coupled through the RF switch with a RF proximity detection antenna and to receive only, using the RF proximity detection antenna, a fifth RF signal, and
a second RF chain electrically coupled with a second dual band antenna and configured, when the mode signal is set to the 2×2 MIMO mode or the 1×2 MIMO mode, to transmit and receive third and fourth dual band RF signals using the first dual band antenna.

16. The system of claim 15, wherein the RF proximity detection antenna comprises a substrate of an electrically conductive material including a plurality of separate apertures formed in the substrate, one or more of the separate apertures comprise passive slits that are electrically decoupled from the RF switch, and another one or more of the separate apertures comprises an antenna having a length edge electrically coupled with the RF switch and an opposing length edge electrically coupled with a ground potential.

17. The system of claim 16, wherein the antenna includes dimensions configured to detune the antenna below a target frequency.

18. The system of claim 15, wherein the RF proximity detection antenna is configured to generate the second RF signal in response to an external wireless device that transmits the fifth RF signal and is placed directly on, in near field proximity to, or in very close near field proximity to the RF proximity detection antenna.

19. A radio frequency (RF) device, comprising:
an integrated circuit (IC) having circuitry including
RF circuitry configured to implement a 2×2 Multiple-Input/Multiple-Output (MIMO) mode and a 1×2 MIMO mode, the RF circuitry configured to reversibly switch between the 2×2 MIMO mode and the 1×2 MIMO mode in response to a mode signal electrically coupled with a RF switch,
a first RF chain electrically coupled with the RF switch and configured, when the mode signal is set to the 2×2 MIMO mode, to be electrically coupled through the RF switch with an external first dual band antenna and to transmit and receive, using the external first dual band antenna, first and second dual band RF signals, and
the first RF chain configured, when the mode signal is set to the 1×2 MIMO mode, to be electrically coupled through the RF switch with an external RF proximity detection antenna, and to receive only, using the external RF proximity detection antenna, a fifth RF signal, and
a second RF chain electrically coupled with an external second dual band antenna and configured to transmit and receive third and fourth dual band RF signals in the 1×2 or 2×2 MIMO modes.

20. The device of claim 19, wherein the external RF proximity detection antenna comprises a substrate of an electrically conductive material including a plurality of separate apertures formed in the substrate, one or more of the separate apertures comprise passive slits that are electrically decoupled from the RF switch, and another one or more of the separate apertures comprises an antenna having a length edge electrically coupled with the RF switch and an opposing length edge electrically coupled with a ground potential.
